(19) United States
(12) Patent Application Publication
(10) Pub. No.: US 2024/0280535 A1
(43) Pub. Date: Aug. 22, 2024

(54) LOCAL SENSING AND CONTROL OF PH FOR PARALLELIZED SYNTHESIS

(71) Applicant: President and Fellows of Harvard College, Cambridge, MA (US)

(72) Inventors: Donhee Ham, Cambridge, MA (US); Woo-Bin Jung, Cambridge, MA (US); Han Sae Jung, Cambridge, MA (US); Jun Wang, Cambridge, MA (US); Young-Ha Hwang, Cambridge, MA (US); Henry Julian Hinton, Cambridge, MA (US); Jeffrey T. Abbott, Cambridge, MA (US); Hongkun Park, Cambridge, MA (US)

(73) Assignee: President and Fellows of Harvard College, Cambridge, MA (US)

(21) Appl. No.: 18/569,809

(22) PCT Filed: Jun. 13, 2022
(86) PCT No.: PCT/US2022/033235

§ 371 Date: Dec. 13, 2023

Related U.S. Application Data
(60) Provisional application No. 63/210,430, filed on Jun. 14, 2021.

(51) Int. Cl. G01N 27/416; G01N 27/27; G01N 27/30

(52) U.S. Cl. CPC G01N 27/4167; G01N 27/27; G01N 27/302

(57) ABSTRACT

Devices and methods for controlling the local pH of solutions (e.g., for parallelized polymer synthesis) are generally described. These may offer several advantages, including the ability to control pH using a plurality of pixels, and/or the ability to sense the pH associated with each pixel, according to certain embodiments. In some embodiments, such devices are used to selectively synthesize polymer sequences (e.g., DNA sequences) associated with each pixel. The pixels can, in some embodiments, comprise electrodes that can apply an electrical potential or current to a solution comprising an electrically sensitive pH modifier. In some cases, reaction of the electrically sensitive pH modifier may cause a change in pH. The pixels may comprise circuit components that can operate in multiple modes (e.g. as potentiostats, galvanostats, or open-circuit potential sensors capable of sensing local pH).

### RELATED APPLICATIONS

This application claims priority under 35 U.S.C. § 119(e) to U.S. Provisional Application No. 63/210,430, filed Jun. 14, 2021, and entitled “Local Sensing and Control of pH for Parallelized Synthesis,” which is incorporated herein by reference in its entirety for all purposes.

### GOVERNMENT FUNDING

This invention was made with government support under 2019-19081900002 awarded by U.S. Office of the Director of National Intelligence—IARPA. The government has certain rights in the invention.

### TECHNICAL FIELD

The control of local pH environments using integrated circuits is generally described.

### BACKGROUND

Control of pH enables a quantitative control of a wide range of pH-dependent chemical and biochemical processes. By creating local pH microenvironments in parallel, these processes can be greatly parallelized and densified. Applications, such as microarray synthesis of DNA and peptides, often require an array-wide localization of pH to facilitate spatio-selective removal of protecting groups from existing strands for further elongation. However, dense, array-wide confinement of pH is very challenging due to fast diffusion of protons. Thus, improvements are needed to realize dense localization of pH across a microelectrode array.

### SUMMARY

The subject matter of the present disclosure involves, in some cases, interrelated products, alternative solutions to a particular problem, and/or a plurality of different uses of one or more systems and/or articles.

In one aspect, a device is provided. According to certain embodiments, the device comprises: a substrate comprising an integrated circuit comprising a plurality of pixels, wherein at least some of the pixels in the plurality comprise a first electrode defining a first interior, a second electrode defining a second interior, and a pH sensor, wherein the first interior is at least partially contained within the second interior, and wherein the pH sensor is present within the first interior and/or the second interior.

In another aspect, a device is provided. According to certain embodiments, the device comprises: an integrated circuit comprising a plurality of pixels, wherein at least some of the pixels in the plurality comprise a first electrode, a second electrode, and a pH sensor; and a solution contacting the plurality of pixels, the solution containing an electrically sensitive pH modifier.

In still another aspect, a device is provided. According to certain embodiments, the device comprises: a fluidic chamber having a substrate comprising an integrated circuit defining a plurality of pixels, wherein at least some of the pixels in the plurality comprise a first electrode defining a first interior and a second electrode defining a second interior, and an OCP sensor in electrical communication with the first electrode.

In yet another aspect, a device is provided. According to certain embodiments, the device comprises: an integrated circuit comprising a plurality of pixels, wherein at least some of the pixels in the plurality comprise a first electrode defining a first interior and a second electrode defining a second interior, and wherein at least 90% of the plurality of pixels can independently be operated as a potentiostat, a galvanostat, or an OCP sensor.

In one aspect, a method is provided. According to certain embodiments, the method comprises: exposing a substrate comprising an integrated circuit comprising a plurality of pixels to a solution containing as electrically sensitive pH modifier, wherein at least some of the pixels comprise a first electrode defining a first interior, a second electrode defining a second interior, and a pH sensor; applying a current while determining voltage within a subset of the pixels, wherein the applied current within the subset of pixels causes oxidation or reduction of the electrically sensitive pH modifier depending on the polarity of the applied current; determining the pH within at least some pixels of the subset using the pH sensor.

In another aspect, a method is provided. According to certain embodiments, the method comprises: exposing a substrate comprising an integrated circuit comprising a plurality of pixels to a solution containing an electrically sensitive pH modifier, wherein at least some of the pixels comprise a first electrode defining a first interior, a second electrode defining a second interior, and a pH sensor; applying a voltage while determining current within a subset of the pixels, wherein the applied voltage within the subset of pixels causes oxidation or reduction of the electrically sensitive pH modifier depending on the polarity of the applied voltage; and determining the pH within at least some pixels of the subset using the pH sensor.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1A-1B presents a pixel of an integrated circuit, according to certain embodiments;

FIGS. 2A-2C present schematic, top-view representations of pixels comprising electrodes and electrode interiors, according to certain embodiments;

FIG. 3 presents a schematic representation of the reaction of an electrically sensitive pH modifier, according to certain embodiments;

FIGS. 4A-4C present exemplary circuit components, according to certain embodiments

FIG. 5 presents a circuit that can be independently operated as a potentiostat, a galvanostat, or an OCP sensor, according to certain embodiments;

FIG. 6 presents a circuit that can be independently operated as a potentiostat, a galvanostat, or an OCP sensor, according to certain embodiments;

FIGS. 7A-7B present schematic illustrations of the elongation of polymer sequences, according to certain embodiments;

FIG. 8A presents an image of a packaged chip, according to certain embodiments;

FIG. 8B presents a top-view image of a pixel array of an integrated circuit, according to certain embodiments;

FIG. 8C presents a top-view image of a pixel of an integrated circuit, according to certain embodiments;

FIG. 8D presents a cross-sectional schematic illustration of a pixel of an integrated circuit, according to certain embodiments;

FIGS. 9A-9C present spatiotemporal control of pH with quinone chemistry, according to certain embodiments;

FIGS. 10A-10B presents the pH of an exemplary pixel as a function of time, according to certain embodiments;

FIGS. 11A-11C present the local control of pH using an integrated circuit, according to certain embodiments;

FIG. 12A presents a calibration curve for fluorescent intensity of a probe as a function of pH, according to certain embodiments;

FIGS. 12B-12C present fluorescent, probe-based measurement of pH on an exemplary integrated circuit, according to certain embodiments;

FIG. 13 presents a fluorescent image of a nucleotide deposited at a plurality of reaction sites, according to certain embodiments;

FIG. 14A presents spatiotemporal control of pH with current provided to an anode but no current provided to a cathode, according to certain embodiments;

FIG. 14B presents locations on an integrated circuit wherein OCP and pH were measured for FIG. 14A, according to certain embodiments;

FIG. 14C presents spatiotemporal control of pH with current provided to an anode but no current provided to a cathode, according to certain embodiments;

FIGS. 15A-15F present an array-wide construction of electrochemical walls for pH localization, according to certain embodiments;

FIGS. 16A-16C present pH-gated molecular state encoding, according to certain embodiments;

FIGS. 17A-17B present spatio-selective control of DNA deprotection chemistry for array-wide, enzymatic elongation of DNA on a removable glass substrate, according to certain embodiments

FIGS. 18A-18B present simulations of the pH distribution of a solution contacting an exemplary pixel, according to certain embodiments; and

FIGS. 19A-19B present simulations of the pH distribution of a solution contacting an exemplary pixel, according to certain embodiments.

### DETAILED DESCRIPTION

Devices and methods for controlling the local pH of solutions (e.g., for parallelized polymer synthesis) are generally described. These may offer several advantages, including the ability to control pH using a plurality of pixels, and/or the ability to sense the pH associated with each pixel, according to certain embodiments. In some embodiments, such devices are used to selectively synthesize polymer sequences (e.g., DNA sequences) associated with each pixel. The pixels can, in some embodiments, comprise electrodes that can apply an electrical current or potential to a solution comprising an electrically sensitive pH modifier. In some cases, reaction of the electrically sensitive pH modifier may cause a change in pH. The pixels may comprise circuit components that can operate in multiple modes (e.g., as potentiostats, galvanostats, or open-circuit potential sensors capable of sensing local pH).

Controlling local pH environments is an important and challenging part of certain methods of parallel chemical synthesis, such as synthesis of macromolecules (e.g., DNA). Improvements in methods for parallel chemical synthesis of macromolecules can provide enormous value for applications such as DNA memory and the synthesis of sequence libraries, which rely on efficient parallel synthesis. The present disclosure generally relates to devices and methods for controlling the local pH of solutions, which may be useful for various applications, including but not limited to, parallel chemical synthesis of macromolecules, e.g., by precisely controlling and sensing the chemical environment of the parallel chemical synthesis with high spatial resolution. This may be useful for chemical synthesis of DNA, or other applications such as those described herein.

As a non-limiting example, the following presents the parallel chemical synthesis of nucleotides using a 16×16 array of pixels—each pixel capable of sensing and controlling the local pH environment—to selectively add nucleotides to some pixels but not others, allowing parallelized synthesis of as many as 256 DNA sequences. However, it should be understood that this presentation is by way of example only, and in other embodiments such those described herein, different sizes of pixel arrays may be used (for example, fewer or more than 256 DNA sequences), and/or such devices and methods may be used for applications other than DNA synthesis.

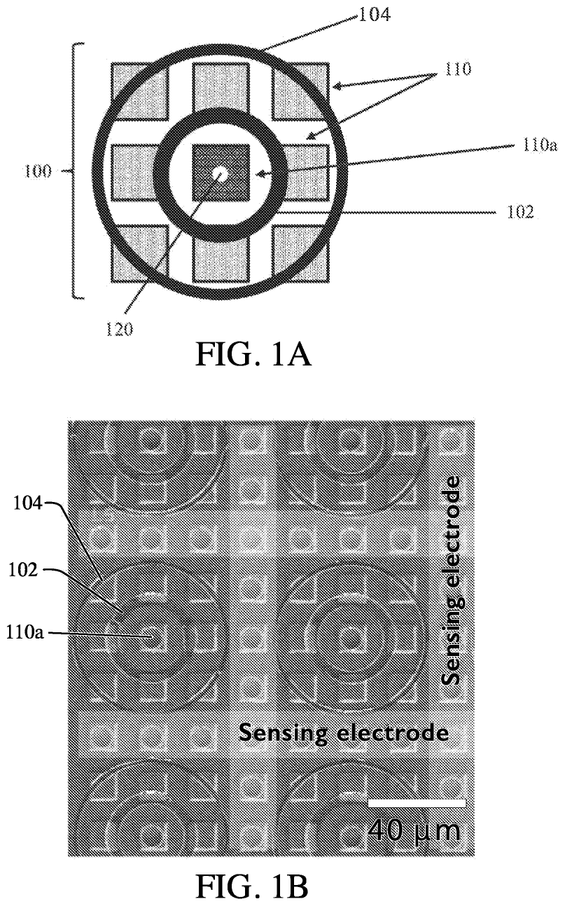

This particular example is generally directed to a device capable of synthesizing DNA sequences in parallel. In this example, an integrated circuit may be present within a wall of the chamber of the device. A square, 16×16 array of pixels of the integrated circuit are, according to this example, configured to control local pH of a solution using a pair of concentric, annular electrodes. It should be understood that in other embodiments, other numbers of pixels, shapes of the electrodes, array shapes, etc. may also be used, e.g., as discussed herein. Each pixel of this example comprises nine electrode pads, arranged in a 3×3 grid. For example, FIG. 1A presents a top view of pixel 100, comprising pads 110 arranged in a 3×3 grid. Central pad 110a of pixel 100 uses an open circuit potential (OCP) pH sensor, according to this example. For example, in FIG. 1A, pads 110 adjacent to the central pad are connected to form first electrode 102, surrounding central pad 110a, where the first electrode is annular. The pads forming the corners of the 3×3 grid are connected to second electrode 104, which surrounds first electrode 102 and also has an annular shape, in this example.

In some cases, the ability to detect pH at each pixel is advantageous for monitoring reaction conditions, and/or calibrating the integrated circuit. FIG. 1B presents a scanning electron microscope image of exemplary pixels formed in a square array and following the design illustrated in FIG. 1A. Between each adjacent pair of exemplary pixels of the array of exemplary pixels is a row or column of additional sensing electrodes, which may be operated as OCP sensors to detect pH between pixels, in this example.

According to some embodiments, independent control of the currents at the first electrode and the second electrode can be used to control the local pH of the solution proximate the pixel. Other techniques, such as voltage control, are also possible in other embodiments. Thus, a square array of pixels can, in some embodiments, control the local pH of a solution. For example, the pixels may be used to control local currents and/or voltages that can cause the reaction of an electrically sensitive pH modifier, such as a quinone, at each pixel. As discussed herein, a quinone or other electrically sensitive pH modifiers may react to voltages by altering their proton state, e.g., by producing or consuming H⁺. Increasing the voltage can result, for example, in deprotonation of the acid, resulting in the formation of an electrically sensitive conjugate and a change in the local pH. Accordingly, by directly (via voltage application) or indirectly (via current injection) controlling the voltage around a quinone or other electrically sensitive pH modifier, the pH of the surrounding solution may also be controlled. Accordingly, in this example, the pH at each pixel can be controlled, e.g., independently of other pixels within the array, for instance by controlling the voltage and/or the current applied between the first and second electrodes within a pixel.

Thus, in some cases, for example, the electrically sensitive pH modifier is controlled, by controlling the voltage and/or current in a first subset of the plurality of pixels to produce a pH change, e.g., without producing the pH change in a second subset of the plurality of pixels. For instance, changing the voltage and/or current within the subset of pixels may alter the protonation state of the electrically sensitive pH modifier, thereby controlling the pH. In some embodiments, controlling the protonation state of the electrically sensitive pH modifier, and thus the pH, is useful for forming polymer sequences, e.g., via parallelized synthesis of distinct polymer sequences (e.g., DNA sequences) associated with each pixel, for instance, as discussed herein.

It should be understood, however, that these examples are presented by way of explanation and not limitation; other aspects and embodiments are also discussed below.

Certain aspects of the present disclosure are directed towards devices comprising integrated circuits. Integrated circuits may comprise a plurality of pixels. The pixels may include a configuration of electrodes, for example, that are used to control pH, for example, the pH of a solution near the pixel. The solution may be contained, at least in part, by a substrate, e.g., comprising the integrated circuit; for instance, the integrated circuit may be present within a portion of the substrate, and used to control the pH of a solution contained by the substrate. Thus, in some embodiments, for example, at least some of the pixels are configured to control local pH of a solution. For example, according to certain embodiments, some or all of the pixels are configured to control local pH of the solution. In some embodiments, the pH is controlled via applying a potential (e.g., using the electrodes), namely by voltage and/or current stimulation. In some embodiments, the pH is controlled via applying a current (e.g., using the electrodes), namely by a current stimulation.

Regardless of the mode of stimulation, pH control may be monitored by a measuring open circuit potential at one or more electrodes, namely by OCP sensing. In some embodiments, stimulation may be exclusively by voltage stimulation, exclusively by current stimulation, or may be configured differently with a first subset of pixels employing voltage stimulation, and a second subset of pixels employing current stimulation using the configurable pixel circuits in the multifunction CMOS substrate as will be described below.

The inventors have recognized and appreciated that aspects of the present disclosure provide electrodes that may be independently configured to operate in any of three modes concurrently: 1) potentiotstat mode (where potential is applied and current is measured), 2) galvanostat mode (where current is applied and voltage is measured), and 3) open circuit potential (OCP) sensor mode (where OCP is measured and can be related to concentrations of chemical species). In particular, the ability to apply current stimulation for pH control has certain advantages over voltage stimulation for pH control. Without wishing to be bound by a particular theory, current stimulation may provide better quantitative control because it directly tunes the rate at which redox reactions occur, making the stimulation protocol more robust and consistent.

The pixels may control pH within a proximate region of the solution (e.g., a radially-symmetric region of the solution within or proximate the electrodes). In some embodiments, the pixels define sites (e.g., reaction sites) proximate to the pixels. For example, in some embodiments, the pixel defines a site (e.g., a reaction site) based on its ability to control the pH of that site, (e.g., the pH of a solution contacting that site).

In some cases, some or all of the pixels may have an electrode configuration that allows the pH near the pixel to be at least partially controlled. For instance, at least some of the pixels may include a configuration of electrodes, e.g., a first electrode and a second electrode. For example, FIG. 1A presents an exemplary schematic illustration of pixel 100 comprising first electrode 102 and second electrode 104. In this figure, first electrode 102 is an inner concentric circle while second electrode is a surrounding outer circle. However, it should be understood that the configuration shown in FIG. 1A is by way of example only, and that other suitable electrode configurations are discussed in more detail below.

In addition, in some embodiments, at least some of the pixels comprise a pH sensor. For example, in FIG. 1A, pixel 100 may comprise a pH sensor, e.g., located at 110a. In certain embodiments, some or all of the pixels comprise a pH sensor. The pH sensor may include an OCP sensor, or other types of pH sensors, e.g., as described herein. As discussed herein, the pH sensor can be used, in certain embodiments, to determine the pH of the solution contacting the sensor. This can advantageously allow monitoring of reaction processes occurring at the pixels in some instances, e.g., to confirm that reactions at the pixels occur under appropriate pH conditions, according to certain embodiments. As another example, according to certain embodiments, local pH measurements can be used to locally monitor and subsequently calibrate or control electronic settings (e.g., current, voltage, etc.) of the pixels, e.g., to control the pH proximate the pixel.

In some embodiments, the integrated circuit comprises one or more pads, e.g., arranged in an array, such as a rectangular array. For example, a pixel may comprise 1, 2, 3, 4, 5, 8, 9, 10, 12, 16, or more pads, e.g., which can be used to control voltage and/or current supplied to the electrodes within a pixel. According to certain embodiments, the pads has a spatial arrangement within a pixel. For example, according to certain embodiments, the pads are arranged in a square or rectangular grid. For example, the pads may be arranged in a 2×2 grid, a 3×3 grid, a 2×4 grid, a 4×4 grid, in any other suitable square or rectangular grid.

In certain embodiments, some or all of the pixels contain other circuits as well, besides those used to control pH. For example, as discussed herein, some or all of the pixels may contain pH sensors, or other electronic components, such as those disclosed herein.

As mentioned, the pixels may be contained within a substrate in some cases. In certain embodiments, the substrate is part of a wall of a chamber (e.g., a fluidic chamber) able to contain a fluid, e.g., in which the pH can be controlled as discussed herein. The fluidic chamber, in some embodiments, includes, on one side of the fluidic chamber, at least a portion of an integrated circuit. According to certain embodiments, the fluidic chamber includes a substrate on one side of the fluidic chamber (e.g., a substrate comprising an integrated circuit). For example, the substrate may comprise a CMOS or an integrated circuit, and the pH of fluid contained by the substrate (e.g., in a chamber) may be controlled as discussed herein.

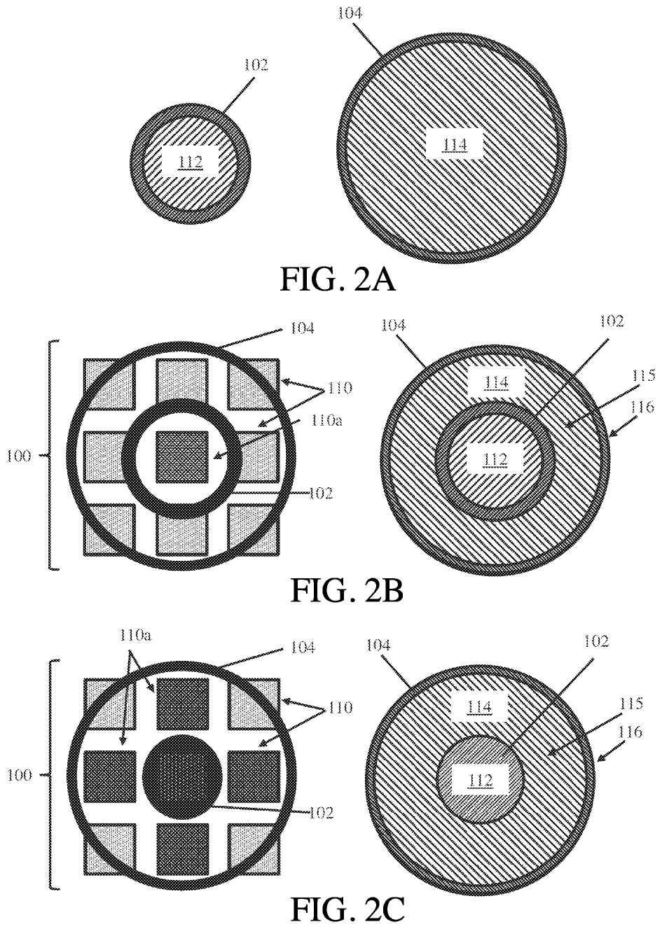

According to certain embodiments, electrodes as described herein have a shape that defines an interior. For example, the first electrode may have a first interior and/or the second electrode may have a second interior. To illustrate this principle, FIG. 2A presents a schematic illustration of exemplary first electrode 102 and exemplary second electrode 104 (separated from one another, for visual clarity), first electrode defining first interior 112 (the indicated crosshatched region) and second electrode 104 defining second interior 114. In some embodiments, an electrode interior partially or completely contains the interior of another electrode. For example, according to certain embodiments, the second interior (e.g., as defined by the second electrode) is at least partially contained within the first interior (e.g., as defined by the first electrode). According to certain embodiments, the first interior is at least partially contained within the second interior. In some embodiments, an electrode interior completely contains the interior of another electrode. FIG. 2B presents a side-by-side representation of a pixel and the electrode interiors defined by the electrodes of that pixel, according to one embodiment. FIG. 2B illustrating an embodiment where second interior 114 completely contains first electrode 102 and first interior 112, while first interior 112 at least partially contains second interior 114. According to certain embodiments, the first electrode is a positive electrode that is configured to have a positive voltage against a counter electrode or a positive current towards a counter electrode and the second electrode is a negative electrode that is configured to have a negative voltage against a counter electrode or a negative current towards a counter electrode. In some embodiments, the first electrode is a negative electrode and the second electrode is a positive electrode, or vice versa. In some embodiments, the positive electrode is an anode, and the negative electrode is a cathode.

In certain embodiments, the second interior contains a portion that is not a portion of the second electrode. For example, in certain embodiments, the second electrode (e.g., as defined by the second electrode) may be annular. In certain embodiments, the first interior contains a portion that is not a portion of the first electrode. For example, in certain embodiments, the first electrode (e.g., as defined by the first electrode) may be annular. In some embodiments, the first interior does not contain a portion that is not a portion of the first electrode. For instance, the first electrode may be a disk. FIG. 2C presents a side-by-side representation of a pixel and the electrode interiors defined by the electrodes of that pixel, according to one embodiment. FIG. 2C illustrates second electrode 104, which is annular, and which defines second interior 114 that comprises portion 115, which is not a portion of second electrode 104, and portion 116, which is a portion of second electrode 104. FIG. 2C presents first electrode 102 as a disk, which therefore does not contain a portion of first interior 112 that is not a portion of first electrode 102. One advantage of annular electrodes is that, according to certain embodiments, an outer electrode helps to contain the pH change associated with an inner electrode, such that the pH change is more effectively localized to the single pixel. However, it should be understood that annular electrodes are not required in all embodiments.

According to certain embodiments, a pH sensor (as described in more detail herein) is present. The pH sensor may be within the first interior (e.g., as defined by the first electrode). The pH sensor may, according to certain embodiments, be within the second interior (e.g., as defined by the second electrode). In some embodiments, the pH sensor is within both the first interior and the second interior. For example, in FIG. 2B, pad 110a may comprise a pH sensor within both first interior 112 and second interior 114. In addition, in some embodiments, the pH sensor is outside of the first interior and/or outside of the second interior.

In certain embodiments, the first electrode and the second electrode are concentric (i.e., they share a common center, such as a centroid). For example, in FIG. 1A, first electrode 102 and second electrode 104 are concentric, sharing common center 120. In this figure, four underlying electrode pads were connected to simplify the fabrication process. However, this is not a requirement for all embodiments. These electrodes can be fabricated on a pre-defined array of passivated metal pads on a CMOS substrate by 1) using photolithography to define concentric patterns on a photoresist, 2) removing the foundry passivation layer of the CMOS substrate by dry etching to expose the underlying metal pads, 3) depositing a desired metal (e.g., Ti/Pt) layer onto the exposed metal pads, and 4) performing a lift-off process. According to certain embodiments, the pH sensor overlaps the common center. However, it should be understood that in other embodiments, the electrodes need not be concentric and are not required to share a common center.

The pH sensor may be of any suitable type. For example, the pH sensor may be an OCP sensor, a two electrode sensor (e.g., a combination sensor), a three electrode sensor (e.g., a differential sensor), an indicator-based sensor (e.g., that relies on detection of a colorimetric or fluorescent pH indicator), or the like. According to certain embodiments, more than one sensor is present within a pixel. Examples of pH sensors are discussed in more detail herein.

In some embodiments, some or all of the pixels comprise one or more pads, e.g., that connect, e.g., physically and/or electrically, to an electrode, for instance, an annular electrode such as present herein. In some embodiments, a pixel defines a site (e.g., a reaction site) based on its ability to control the pH of that site. For example, when operated, the pixel may control the pH of a region of the solution proximate the pixel (e.g., a radially-symmetric region of solution).

For example, according to certain embodiments, the pixel is used to produce a voltage and/or current to control the pH proximate the pixel. For instance, the pixel may include electrodes able to produce a current and/or voltage that controls the pH of an electrically sensitive pH modifier present, e.g., in solution near the pixel. In some cases, control of the pH may also be a function of the electrically sensitive pH modifier (for example, the type, concentration, etc. of the electrically sensitive pH modifier), and/or a function of other components of the solution near the pixel.

In some cases, a pixel (e.g., having structures such as those described herein) may be used to maintain the pH near the pixel to a desired level. For example, the pH may be controlled to maintain the pH of greater than or equal to 1, greater than or equal to 2, greater than or equal to 3, greater than or equal to 4, greater than or equal to 5, greater than or equal to 6, greater than or equal to 7, greater than or equal to 8, greater than or equal to 9, or greater at a pixel. According to certain embodiments, the pH is be controlled to be less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, or less at the site. Combinations of these ranges are possible. For example, according to certain embodiments the pH is controlled to be be greater than or equal to 2 and less than or equal to 9 at a pixel. In some embodiments, reactions occur at a site. According to some embodiments, for example, polymer sequences are formed at a site, as is described in more detail below.

As mentioned, in some embodiments, an electrically sensitive pH modifier, for example, a voltage sensitive pH modifier, is used to change the pH of a solution. The electrically sensitive pH modifier may undergo reaction caused directly (via applying voltage) or indirectly (via applying current), e.g., using an applied electrical potential (i.e., voltage). For example, in some cases the electrically sensitive pH modifier may be oxidized in response to the applied electrical potential. The electrically sensitive pH modifier may be an electrically sensitive acid. In some cases, oxidation of the electrically sensitive acid results in the formation of H⁺ ions. In some cases, oxidation of the electrically sensitive acid results in the formation of an electrically sensitive conjugate. In some embodiments, the electrically sensitive acid undergoes reaction to form a single H⁺ ion. However, in some cases, the electrically sensitive conjugate of an electrically sensitive acid is also an electrically sensitive acid, and thus capable of undergoing further oxidation reactions that will result in the formation of H⁺ ions (e.g., 2, 3, 4, etc., H⁺ ions). In addition, the electrically sensitive pH modifier may be an electrically sensitive base. In some embodiments, reaction of the electrically sensitive base results in the consumption of H⁺ ions. In some embodiments, reaction of the electrically sensitive base results in the formation of an electrically sensitive conjugate.

In some cases, the reaction of an electrically sensitive pH modifier may be reversible. For example, in some cases, an electrically sensitive pH modifier may be ionized by an applied voltage and/or current. The ionized electrically sensitive pH modifier may return to a non-ionized state in response to change in (e.g., a removal of) applied voltage and/or current. In some embodiments, however, the reaction of an electrically sensitive pH modifier is irreversible. For example, in some embodiments the electrically sensitive pH modifier undergoes an irreversible reduction reaction under an applied voltage and/or current. In some embodiments, the reduced electrically sensitive pH modifier does not return to a non-ionized state in response to a change in (e.g., a removal of) applied voltage and/or current.

In certain embodiments, the electrically sensitive pH modifier undergoes reaction caused by applied electrical potential (e.g., voltage) or applied current. The reaction of an electrically sensitive pH modifier to form electrically sensitive conjugates is generally reversible, with an equilibrium influenced by the applied potential and/or current, with the result that local changes in applied potential can drive local changes in the concentration of H⁺ ions, resulting in local pH changes, according to certain embodiments.

In certain embodiments, the electrically sensitive pH modifier is a hydroquinone. According to certain embodiments, the hydroquinone is an electrically sensitive acid. Any suitable hydroquinone may be an electrically sensitive pH modifier. Hydroquinone typically includes an aromatic structure, e.g., comprising two hydroxy groups. As a non-limiting example, according to certain embodiments, the hydroquinone comprises a single, six-membered aromatic ring comprising an even number of hydroxy substituents (e.g., 2, 4, 6, or more hydroxy substituents). In some embodiments the two hydroxy substituents are arranged in an ortho-configuration, arranged in a meta-configuration, or arranged in a para-configuration. For example, according to some embodiments, the quinone is 2,5-dimethyl-1,4-hydroquinone, structure (I) below.

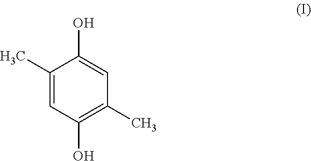

In certain embodiments, the electrically sensitive pH modifier is a quinone. According to certain embodiments, the quinone is an electrically sensitive base. Any suitable quinone may be an electrically sensitive pH modifier. Quinones typically include a fully conjugated cyclic structure, e.g., comprising an even number of carbonyl carbons (e.g., 2, 4, 6, or more carbonyl carbons) within an aromatic structure. As a non-limiting example, according to certain embodiments, the quinone comprises a single, six-membered aromatic ring comprising two carbonyl carbons. In some embodiments the two carbonyl carbons are arranged in an ortho-configuration, arranged in a meta-configuration, or arranged in a para-configuration. For example, in one embodiment, the quinone is 1,4-benzoquinone. As another example, according to some embodiments, the quinone is 2,5-dimethyl-1,4-benzoquinone, structure (II) below.

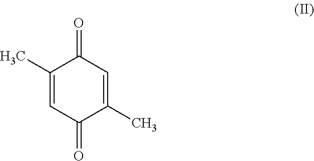

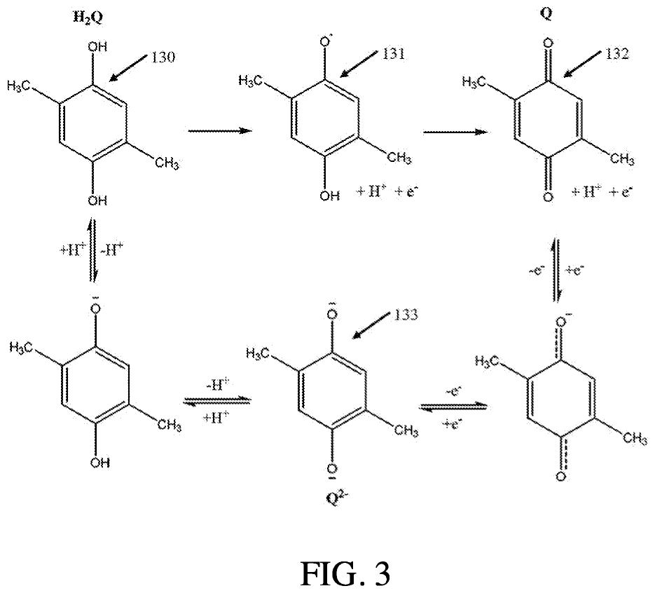

A non-limiting example of these principles is presented in FIG. 3, where 2,5-dimethyl-1,4-hydroquinone, a non-limiting example of electrically sensitive acid 130, is irreversibly oxidized in response to an applied electrical potential to form electrically sensitive conjugate 131, a radical species, in addition to an H⁺ ion and an electron. While the structure of 2,5-dimethyl-1,4-hydroquinone is specifically drawn, it should be understood that the same chemistry could occur with any hydroquinone, indicated as H₂Q. Electrically sensitive conjugate 131 is also an electrically sensitive acid, according to some embodiments, because electrically sensitive conjugate 131 may be irreversibly reduced to electrically sensitive conjugate 132, 2,5-dimethyl-1,4-quinone. Of course, it should be understood that any hydroquinone H₂Q could undergo reaction to form an associated quinone Q, as indicated in FIG. 3. In some embodiments, these reactions occur in response to a positive current, driven by an applied voltage and/or current.

In some embodiments, electrically sensitive conjugate 132 is itself a voltage-sensitive pH modifier. For example, in some embodiments, electrically sensitive conjugate 132 is reduced in response to an applied voltage that produces a negative current, reversibly forming electrically sensitive base 133. For example, in the case where electrically sensitive conjugate 132 is a quinone (Q), electrically sensitive conjugate 132 may reversibly form an associated quinone dianion (Q²⁻), which acts as electrically sensitive base 133. Of course, while a specific structure is shown in FIG. 3, any quinone Q could be thus reduced to produce an associated quinone dianion Q²⁻. In some embodiments, the electrically sensitive base 133 reacts with H⁺ ions to form electrically sensitive acid 130, as shown in FIG. 3. The reaction of the electrically sensitive base with H⁺ is not, according to some embodiments, associated with an applied voltage and/or current. However, in embodiments such as that of FIG. 3, electrically sensitive base 133 is still considered electrically sensitive, since the concentration of the base depends on the applied voltage. According to certain embodiments, reaction of a quinone dianion Q²⁻ with H⁺ produces a hydroquinone H₂Q, as shown.

According to certain embodiments, a solution is in contact with the pixel. For example, the solution may be in contact with the surface comprising pixels of the integrated circuit. The solution is aqueous, in some embodiments. In some embodiments, the integrated circuit is configured to control the pH of the solution (e.g., using the plurality of pixels). The solution may comprise one or more dissolved species. For example, according to certain embodiments, the solution comprises one or more reagents for a chemical reaction. In some embodiments, the solution comprises an electrically sensitive pH modifier as described above.

The electrically sensitive pH modifier may be present in the solution in any suitable concentration. For example, according to certain embodiments, the electrically sensitive pH modifier is present in a concentration of greater than or equal to 0.1 M, greater than or equal to 0.25 M, greater than or equal to 0.4 M, greater than or equal to 0.5 M, greater than or equal to 0.6 M, greater than or equal to 0.7 M, or more. According to certain embodiments, the electrically sensitive pH modifier is present in a concentration of less than or equal to 2 M, less than or equal to 1.5 M, less than or equal to 1 M, less than or equal to 1 M, less than or equal to 0.8 M, less than or equal to 0.65 M, less than or equal to 0.5 M, or less in some cases. Combinations of these ranges are possible. For example, according to certain embodiments, the electrically sensitive pH modifier is present in a concentration of greater than or equal to 0.1 M and less than or equal to 2 M. According to some embodiments, the electrically sensitive pH modifier is present in a concentration of greater than or equal to 0.2 M, or greater than or equal to 0.65 M, etc. In certain embodiments, the electrically sensitive pH modifier is saturated in solution.

According to certain embodiments, the solution is at rest. In some embodiments, the solution is flowed over the surface of the substrate.

The solution comprising the electrically sensitive pH modifier may contact a plurality of pixels, some or all of which may be used to control the pH of the solution. The pixels may have any suitable structure and may be of any suitable dimensions. According to certain embodiments, the pixels have an average pixel diameter of greater than or equal to 1 micrometer, greater than or equal to 2 micrometers, greater than or equal to 5 micrometers, greater than or equal to 10 micrometers, greater than or equal to 20 micrometers, or greater. According to certain embodiments, the pixels have an average pixel diameter of less than or equal to 100 micrometers, less than or equal to 80 micrometers, less than or equal to 50 micrometers, less than or equal to 30 micrometers, less than or equal to 20 micrometers, or less. Combinations of these ranges are possible. For example, according to certain embodiments the pixels have an average pixel diameter of greater than or equal to 1 micrometer and less than or equal to 100 micrometers. As another example, according to certain embodiments the pixels have an average pixel diameter of greater than or equal to 1 micrometer and less than or equal to 20 micrometers.

In some embodiments, an average interpixel spacing between adjacent pixels is greater than or equal to 5 micrometers, greater than or equal to 10 micrometers, greater than or equal to 20 micrometers, greater than or equal to 30 micrometers, greater than or equal to 40 micrometers, greater than or equal to 50 micrometers, or greater. According to certain embodiments, the average interpixel spacing is less than or equal to 100 micrometers, less than or equal to 70 micrometers, less than or equal to 60 micrometers, less than or equal to 50 micrometers, less than or equal to 40 micrometers, less than or equal to 30 micrometers, less than or equal to 20 micrometers, or less. Combinations of these ranges are possible. For example, according to certain embodiments the average inter-pixel spacing is greater than or equal to 5 micrometers and less than or equal to 100 micrometers.

In some embodiments, the plurality of pixels is an array. For example, the plurality of pixels may be a spatially periodic array. According to some embodiments, the array is one-dimensional (i.e., a 1×n array, where n is any integer greater than 1). According to some embodiments, the array is two-dimensional. The pixels of the array may be arranged in any suitable configuration. For example, the array may be a square array, a rectangular array, a hexagonal array, or a monoclinic array.

Pixels of the array may have any suitable pixel density. According to certain embodiments, the pixel density of the array is greater than or equal to 50 pixels/mm² greater than or equal to 100 pixels/mm² greater than or equal to 200 pixels/mm², greater than or equal to 250 pixels/mm², greater than or equal to 300 pixels/mm², greater than or equal to 500 pixels/mm², or greater. According to certain embodiments, the pixel density of the array is less than or equal to 1,000 pixels/mm², less than or equal to 500 pixels/mm², less than or equal to 300 pixels/mm², or less. Combinations of these ranges are possible. For example, according to certain embodiments the pixel density of the array is greater than or equal to 50 pixels/mm² and less than or equal to 1,000 pixels/mm². As another example, according to certain embodiments, the pixel density is greater than or equal to 250 pixels/mm².

According to certain embodiments, the number of pixels in the plurality of pixels is greater than or equal to 1, greater than or equal to 2, greater than or equal to 5, greater than or equal to 10, greater than or equal to 15, greater than or equal to 20, greater than or equal to 50, greater than or equal to 100, greater than or equal to 500, greater than or equal to 1,000, greater than or equal to 2,000, greater than or equal to 3,000, greater than or equal to 4,000, greater than or equal to 5,000, greater than or equal to 6,000, greater than or equal to 7,000, greater than or equal to 8,000, greater than or equal to 9,000, greater than or equal to 10,000, greater than or equal to 15,000, greater than or equal to 20,000, or greater. According to certain embodiments, the number of pixels in the plurality of pixels is less than or equal to 100,000, less than or equal to 50,000, less than or equal to 20,000, less than or equal to 10,000, or less. Combinations of these ranges are possible. For example, according to certain embodiments the number of pixels in the plurality of pixels is of greater than or equal to 1 and less than or equal to 100,000. As another example, in some embodiments, the number of pixels in the plurality of pixels is greater than or equal to 4,000.

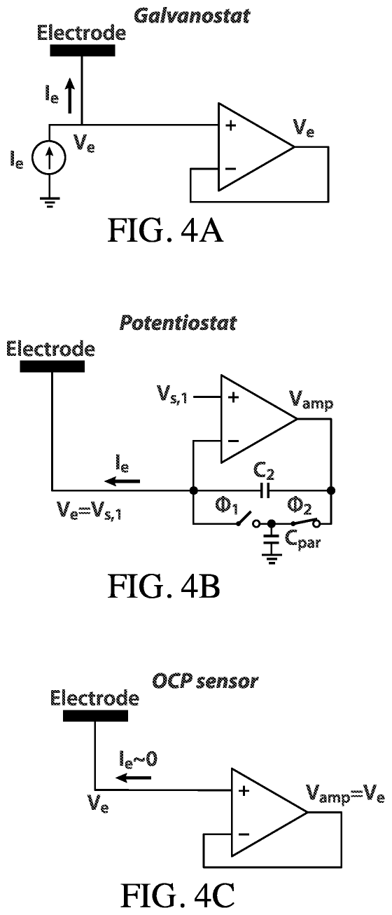

In some aspects, an electrode pad within the integrated circuit may be operable as an open circuit potential (OCP) sensor to detect pH. In some cases, the OCP sensor can be determined and related to the pH or hydrogen ion concentration. One example of an OCP sensor can be seen in FIG. 4C. The OCP sensor may be in electrical communication with an electrode; for example, as is shown in FIG. 4C.

In certain embodiments, an electrode pad within the integrated circuit is operable as a galvanostat, where a current is applied and the resultant voltage is measured. An example of such a circuit can be seen in FIG. 4A, where the galvanostat circuit is in electrical communication with an electrode. In addition, in some cases, an electrode pad within the integrated circuit may be operable as a potentiostat, where an electrical potential is applied and the resultant current measured. A non-limiting example of such a circuit can be seen in FIG. 4B, where the potentiostat circuit is in electrical communication with an electrode.

In addition, in some embodiments, an electrode pad within the integrated circuit can be independently operated as a potentiostat, a galvanostat, or an OCP sensor. Different pixels within the integrated circuit may be operated independently of each other. As a non-limiting example, a first pixel may be operated in one of these modes, while the second pixel may independently be operated in the same or a different mode.

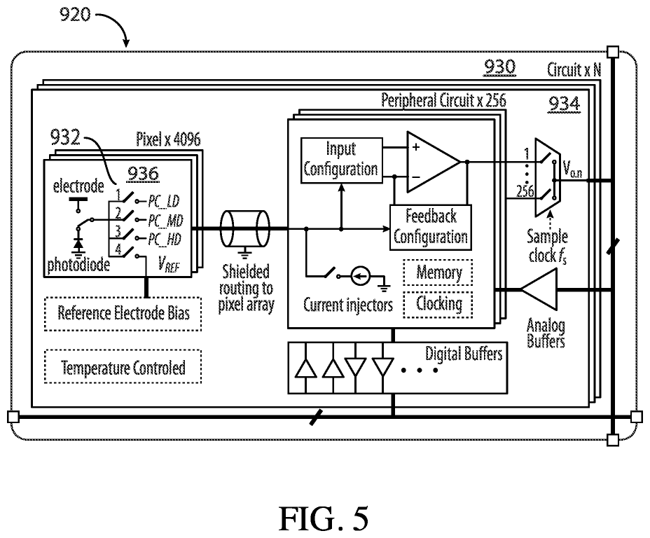

A non-limiting example of such a circuit is shown in FIG. 5. This figure shows a schematic block diagram illustrating an exemplary circuit 930 that may include a plurality of electrode pads 920, in accordance with some embodiments. In circuit 930, a plurality of peripheral circuits 934 are designed to be able to connect to all or a subset of an array of electrodes 936 within the plurality of electrode pads 920. In a non-limiting example, circuit 930 has 256 peripheral circuits. By selective operation of a plurality of switches 932, all or a subset of the peripheral circuits are able to connect to all or a subset of 4096 electrode pads to allow, e.g., high density (HD), medium density (MD) or low density (LD) connections. Any set of arbitrary electrode pads can also act as reference electrode by connection the electrode to the reference electrode bias (VREF). In the non-limiting example described, in HD (MD) connections, a subset of 16×16 (32×32) electrode pads are recorded out of the total 64×64 available electrode pads. This routing design allows scanning of the recording area (16×16 for HD and 32×32 for MD) across the entire available active area (64×64). This example design allows customized experiment setups from pad to pad.

Referring back to FIG. 5, the peripheral circuit 934 may each include, for example, a stimulation circuit and a recording circuit. In some embodiments, the stimulation circuit comprises one or more current injectors. Some aspects of the peripheral circuit design are related to current-based stimulators for electrogenic cells and related methods, as disclosed in International Application Publication. No. WO 2019/010343, Attorney Docket No. H0776.70105WO00, the disclosure of which is hereby incorporated by reference in its entirety. Some aspects may also be related to electronic circuits for analyzing electrogenic cells and related methods, as disclosed in International Application Publication. No. WO 2019/089495, Attorney Docket No. H0498.70647WO00, the disclosure of which is hereby incorporated by reference in its entirety. In addition, some aspects may also be related to U.S. Ser. No. 63,040,412, entitled “Complementary Metal-Oxide-Semiconductor (CMOS) Multi-Well Apparatuses and Methods for Electrical Cell Assessment”; U.S. Ser. No. 63/040,424, entitled “Apparatuses for cell mapping via impedance measurements and methods to operate the same”; or U.S. Ser. No. 63/040,439, entitled “Systems and methods for patterning and spatial electrochemical mapping of cells,” the disclosures of each of which are hereby incorporated by reference in its entirety.

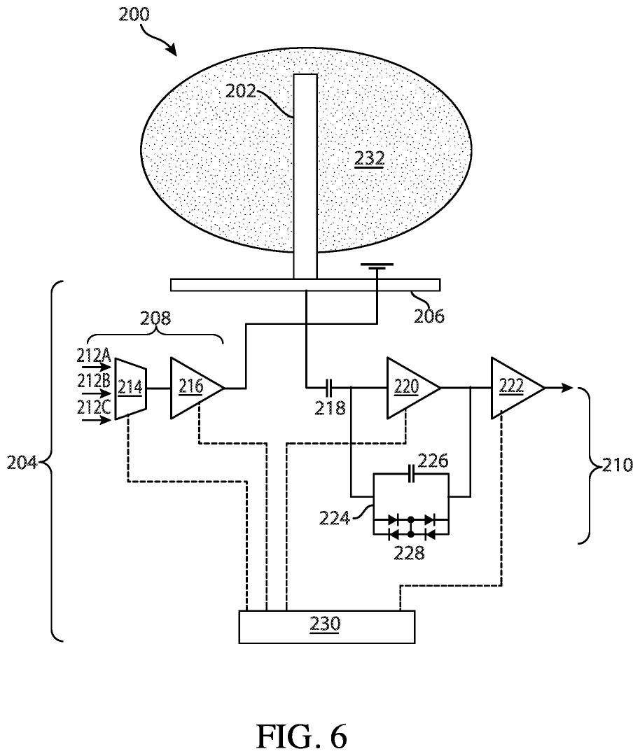

A non-limiting example of stimulation and recording circuits that may be used to implement the potentiostat, galvanostat, and OCP sensor as described above is shown in FIG. 6.

FIG. 6 is a schematic diagram of an exemplary system 200 comprising an electrode 206, a nanowire 202 and a connection site 204 of an integrated circuit, according to some embodiments. It should be appreciated that while nanowire 202 is optional and is not a requirement for system 200. In system 200, connection site 204 comprises metal pad (i.e. electrode) 206, which may be any electrode according to the present disclosure. Metal pad 206 is in electrical communication with stimulator unit 208 and amplifier unit 210. Stimulator unit 208 comprises voltage stimulus sources 212A, 212B, and 212C, multiplexer 214, and stimulator 216. Amplifier unit 210 comprises input capacitor 218, low-noise amplifier (LNA) 220, variable gain amplifier (VGA) 222, and high-pass filter 224. High-pass filter 224 comprises capacitor 226 in parallel with pseudo resistor 228, where pseudo resistor 228 comprises a plurality of feedback diodes. Connection site 204 also comprises local digital memory 230, which is electronically connected to multiplexer 214 and stimulator 216 of stimulator unit 208 and LNA 220 and VGA 222 of amplifier unit 210.

In operation, connection site 204 may be configured to apply an electrical stimulus (e.g., a voltage pulse, current stimulation, etc.) to a solution in direct contact with a surface of the metal pad 206. While biological cell 232 is shown, it should be appreciated that aspects of the system 200 are not limited to application on biologic cells, and system 200 may also operate with a solution environment. Accordingly, digital memory 230 may send signals to allow multiplexer 214 and stimulator 216 of stimulator unit 208 and disable LNA 220 and VGA 222 of amplifier unit 210. Digital memory 230 may also send a signal to multiplexer 214 selecting which of voltage stimulus sources 212A. 212B, and 212C to use to apply a stimulation signal. The stimulation signal may be transmitted from the selected voltage stimulus source of stimulator unit 208 to metal pad 206 and 202.

In some cases, connection site 204 may be configured to record an electrical signal. Accordingly, digital memory 230 may send signals to disable multiplexer 214 and stimulator 216 of stimulator unit 208 and allow LNA 220 and VGA 222 of amplifier unit 210. Digital memory 230 may also control the gain of VGA 222. An electrical signal may be transmitted to metal pad 206 and amplifier unit 210. In amplifier unit 210, the electrical signal may be transmitted through input capacitor 218 to LNA 220, which may increase the voltage of the electrical signal. High-pass filter 224 may remove noise having a frequency below a certain cut-off value. The amplified signal may then be transmitted to VGA 222 to be further amplified, with the gain controlled by digital memory 230. The further amplified signal may then be transmitted to an output multiplexer (not shown).

Some aspects of the stimulation and recording circuit design are related to nanowire arrays for neurotechnology and other applications, as disclosed in International Application Publication. No. WO 2016/112315, Attorney Docket No. H0498.70535WO00, the disclosure of which is hereby incorporated by reference in its entirety.

Some embodiments comprise one or more substrates. In some embodiments, a substrate comprises an integrated circuit (e.g., comprising electrode pads), as described herein. In some embodiments, a substrate does not comprise an integrated circuit. A substrate may comprise a plurality of pixels and/or sites (e.g., reactive sites).

In some embodiments, the plurality of sites are defined on a second substrate. Forming the sites on the second substrate is advantageous, in certain embodiments, for example because the second substrate may be produced more inexpensively, may be disposable, and/or may be more easily functionalized to prepare it for polymerization reactions. According to certain embodiments, the second substrate is removable.

According to one aspect, devices such as those described herein can be used to control the pH at multiple locations, e.g., of a solution contained by the device, e.g., within a fluidic chamber.

For example, according to certain embodiments, a solution containing an electrically sensitive pH modifier is present within a chamber. For example, a solution may be flowed through the chamber, and/or the solution may be relatively stagnant within the chamber.

In some cases, the pH at one or more pixels may be controlled. For example, according to certain embodiments, an applied potential within a subset of pixels causes reaction of the electrically sensitive pH modifier, e.g., to produce or consume protons as described above, thereby changing the pH. For example, in certain embodiments, the electrically sensitive pH modifier is reacted via a change in voltage within a subset of a plurality of pixels. According to some embodiments, reacting the electrically sensitive pH modifier within a subset of pixels produces a first pH change, while in other pixels, the electrically sensitive is not reacted, and no substantial change in pH occurs.

In some embodiments, the subset of pixels that is controlled comprises greater than or equal to 5%, greater than or equal to 10%, greater than or equal to 25%, greater than or equal to 50%, greater than or equal to 75%, greater than or equal to 90%, or more of the plurality of pixels, e.g., at any given moment. According to certain embodiments, the subset of pixels comprises less than or equal to 100%, less than or equal to 90%, less than or equal to 75%, less than or equal to 50%, less than or equal to 25%, less than or equal to 10%, or less of the plurality of pixels. Combinations of these ranges are possible. For example, according to certain embodiments the subset of pixels comprises greater than or equal to 5% and less than or equal to 100% of the plurality of pixels.

Some embodiments further comprise determining the pH within some or all of the pixels of the array. According to certain embodiments, pH is determined using a pH sensor, e.g., present within some or all of the pixels within the array. According to certain embodiments, the pH is determined at greater than or equal to 5%, greater than or equal to 10%, greater than or equal to 25%, greater than or equal to 50%, greater than or equal to 75%, greater than or equal to 90%, or more of the pixels of the subset. According to certain embodiments, the pH is determined at less than or equal to 100%, less than or equal to 90%, less than or equal to 75%, less than or equal to 50%, less than or equal to 25%, less than or equal to 10%, or less of the pixels of the subset. Combinations of these ranges are possible. For example, according to certain embodiments the PH is determined at greater than or equal to 5% and less than or equal to 100% of the subset of pixels.

Determining the pH at the pixels of the array may advantageously allow calibration or control of pixels of the array. For example, determination of the pH may indicate whether an applied potential should be adjusted in order to achieve a desired pH. This may advantageously reduce the difficulty of calibrating the array of pixels to appropriately modulate the pH of previously unstudied concentrations or species of electrically sensitive pH modifiers.

According to some embodiments, controlling the voltage and/or current at a site can be useful for forming one or more polymer sequences at that site, e.g., independently of other sites within an array. In some embodiments, polymer sequences at a site are protected by a protecting group (e.g., a chemical substituent bonded to a terminus of a polymer sequence) that prevents reaction polymer sequences at the site. For example, nucleic acids may be protected by protecting groups such as an -O-DMT (where DMT refers to dimethoxytrityl) or —ONH₂. In various embodiments, a local pH change (e.g., caused by reacting the electrically sensitive pH modifier) can deprotect a polymer sequence (e.g., by modifying or cleaving a protecting group), rendering the polymer sequence suitable for reaction during subsequent polymerization steps performed at the site. According to certain embodiments, selective control of pH at each pixel allows selective control of the progression of polymerization at each site.

According to certain embodiments, the plurality of pixels of the integrated circuit defines a plurality of sites on a substrate, as described above. By producing a first pH change associated with a first subset of the plurality of pixels without producing the first pH change in a second subset of the plurality of pixels, in some embodiments, a first subset of the plurality of sites, defined by the first subset of the plurality of pixels, can be rendered suitable for reaction during subsequent polymerization steps, while a second subset of the plurality of sites, defined by the second subset of the plurality of pixels, is not rendered suitable for reaction during subsequent polymerization steps.

According to certain embodiments, sites are reaction sites. Reaction sites are sites of a substrate, whereon chemical reactions (e.g., polymerization reactions) may take place. Reaction sites may be functionalized. For example, a reaction site may comprise functional groups capable of reacting with monomers (e.g., nucleic acids, amino acids), allowing polymer sequences to be synthesized at the reaction site. In certain embodiments, reaction sites are defined by pixels on a second substrate. This is advantageous, in some embodiments, because the second substrate may be replaced, allowing the integrated circuit to be reused after a polymerization reaction, since polymer sequences are developed on the second substrate rather than on a substrate comprising the integrated circuit.

Many types of polymer sequences may be formed by a process comprising a step of deprotecting a polymer sequence. For example, the polymer sequences formed may comprise nucleotides (e.g., the polymer sequences may comprise DNA or RNA) or peptides. According to certain embodiments, this step is performed using an integrated circuit, as described herein.

Polymer sequences formed at distinct reaction sites may be the same, or may be different. In some embodiments, for example, a polymer sequence formed at a reaction site is unique, e.g., with respect to polymer sequences formed at any other reaction site. One advantage of the devices, articles, and methods described herein is that they may allow the formation of a polymer sequence at a first reaction site to be controlled independently of the formation of a polymer sequence at a second reaction site. Thus an integrated device may be used to form multiple polymer sequences. According to certain embodiments, a number of unique polymer sequences formed may exceed 25%, exceed 50%, exceed 75%, or more of a number of pixels of the plurality of pixels. In some embodiments, a number of unique polymer sequences formed equals a total number of pixels of the plurality of pixels.

One advantage of forming a significant number of unique pixels is that each pixel is used to encode data, according to certain embodiments. For example, according to certain embodiments, a sequence of a polymer (e.g., a DNA sequence, a peptide sequence) may be selected to encode information for later use or retrieval.

In some embodiments, formed polymer sequences are removed from a substrate. Certain embodiments comprise removing at least a subset of the polymer sequences from the plurality of sites. For example, an integrated circuit as described herein is used to synthesize a library of polymer sequences, which can be removed from the reaction sites, according to certain embodiments. As another example a polymer sequence associated with a particular site may be removed from a substrate. This may allow the removed polymer sequence to be analyzed.

In some embodiments, one or more polymer sequences, once synthesized, are analyzed. For instance, the one or more polymer sequences may be sequenced. Generally, a polymer sequence may be sequenced on a substrate (e.g., while it is connected to a substrate), or following removal from a substrate. According to some embodiments, more than one polymer sequences are sequenced.

U.S. Provisional Application No. 63/210,430, filed Jun. 14, 2021, entitled “Local Sensing and Control of pH for Parallelized Synthesis,” is incorporated herein by reference in its entirety for all purposes.

The following examples are intended to illustrate certain embodiments of the present disclosure, but do not exemplify the full scope of the disclosure.

### Example 1

This example describes the synthesis of DNA using an integrated circuit. In this example, DNA was synthesized on a plurality of sites of a second substrate associated with pixels of an integrated surface. The steps of synthesis were performed as follows:

1) A glass substrate serving as the second substrate was cleaned sequentially in 1 M NaOH (aq), 0.1 M HCl (aq), and ethanol. In between application of the solutions, the substrate was rinsed with deionized water. Finally, the glass substrate was treated with an O₂ plasma.

2) A 2% v/v acrylamide (VWR International, Pittsburgh, PA) solution was made by dissolving 1.3 g of acrylamide in 65 mL of deionized water and was purged with nitrogen gas for 15 minutes. Then, 103 mg of N-(5-bromoacetamidylpentyl) acrylamide was dissolved in 1.07 mL of N,N-dimethyl formamide and then added to the acrylamide solution. Then, 75 uL of PlusOne TEMED catalyst (VWR International, Pittsburgh. PA) and 0.65 mL of 0.05 g/mL potassium persulfate were sequentially added to the acrylamide solution. Cleaned glass substrates were placed in the final acrylamide solution for 90 minutes. After 90 minutes of coating, the slides were rinsed with deionized water and dried with nitrogen gas. This produced a silane-free acrylamide-coated (SFA-coated) glass substrate.

3) 20 micromolar DNA in 10 mM phosphate buffered saline (PBS) solution was spotted on the SFA-coated glass substrate for 1 hour. Then, the SFA-coated glass substrate was sequentially rinsed with 0.1 M PBS buffer, 10 mM Tris/10 mM EDTA buffer at pH 8.0, and deionized water. Finally, the SFA-coated glass substrate was dried with nitrogen gas.

4) To change the terminating group of the coupled DNA strands from 3′OH to 3′ONH₂, a DNA-coupled glass substrate was spotted for 5 minutes with an enzymology solution, consisting of 500 micromolar dTTP-3′ONH₂, 8 micromolar TdT enzyme, 1 mM CoCl₂, and 1×Ty buffer.

5) The SFA-coated glass substrate was configured opposite to an integrated circuit.

6) Then, a solution (referred to as a deprotection solution) comprising the electrically sensitive pH modifiers 10 mM 2,5-dimethyl-1,4-hydroquinone (Alfa Chemistry, Ronkonkoma, NY) and 5 mM 2,5-dimethyl-1,4-benzoquinone (Sigma Aldrich, Atlanta, GA), as well as 1 M NaCl (aq), 0.7 M NaNO₂ (aq), and 3% v/v DMSO was added to a chamber, defined on one side by the s SFA-coated glass substrate and on another by the integrated circuit. The same quinone solution was generally used for pH control.

7) After placing the glass substrate on top of the CMOS-MEA, the pH of each site was defined by applying 48 nA of anodic current and −48 nA of cathodic current were applied to a group of selected pixels for 80 seconds to spatio-selectively deprotect the DNA strands' 3′ONH₂ terminating groups. This allowed each pixel of the integrated circuit to be controlled, such that a first subset of the plurality of sites was deprotected and a second subset of the plurality of sites remained protected.

8) The deprotection solution was flushed from the chamber; After deprotection, the glass substrate was washed with deionized water and subsequently dried with nitrogen gas.

9) The deprotected DNA was reacted with an elongation solution comprising a deoxynucleotide triphosphohydrolase (dNTP) to add a nucleotide to the deprotected sites. For elongation of the deprotected strands with Cy5-labelled ddATP, the glass substrate was spotted for 5 minutes with a Cy5-labelling enzymology solution, consisting of 50 micromolar ddATP-Cy5 (Jena Bioscience, Jena, Germany), 8 micromolar TdT enzyme, 1 mM CoCl₂, and 1× Ty buffer.

10) After the elongation, the glass substrate was washed with deionized water and dried with nitrogen gas.

11) Steps 6-10 can be iterated to produce DNA strands at each site.

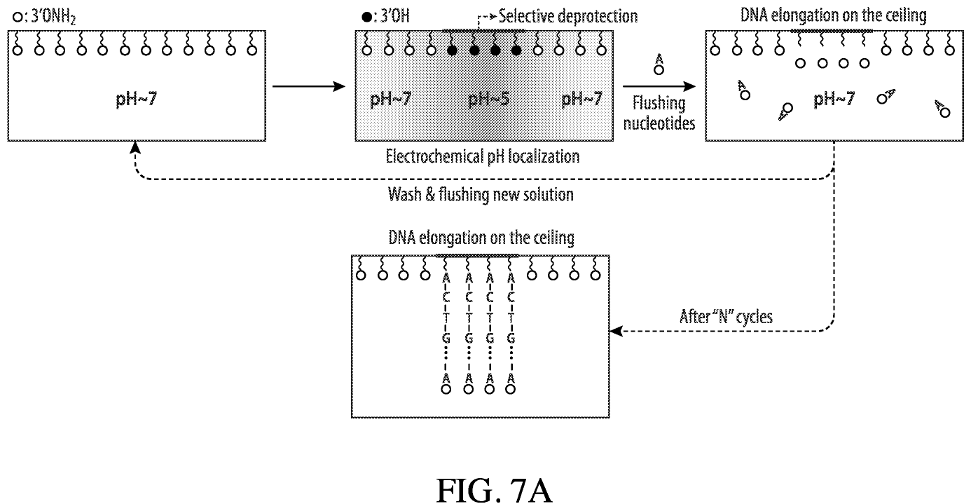

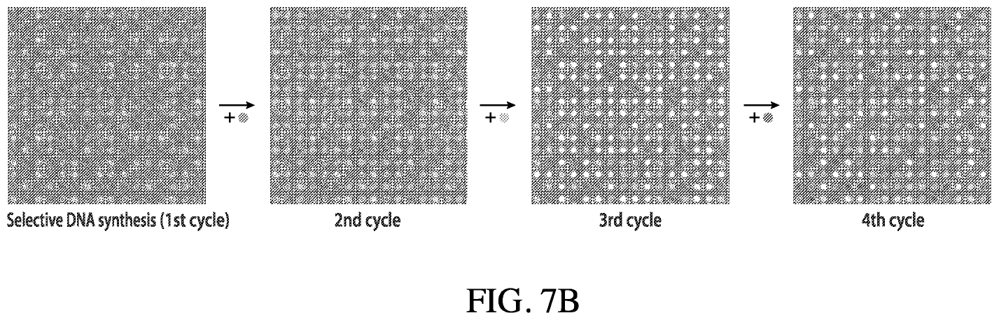

This process of steps 6-10 is schematized in FIGS. 7A-7B, which illustrate the elongation of desired nucleotide sequences at specific positions on the second substrate. FIG. 7A illustrates a side-view of the process, along with the specific method steps. FIG. 7B illustrates the sites from below, with variation in pixel shading to schematically indicate the terminal nucleobase of the sequence. By this procedure, the synthesis of DNA sequences can be parallelized on the chip, with a different DNA sequence produced at each site.

### Example 2

This example describes the fabrication of an exemplary integrated circuit. The integrated circuit, a custom designed CMOS Integrated Circuit, was fabricated in 0.18 micrometer technology. Each chip had an array of 64×64=4,096 Al pads (10.5 micrometer×10.5 micrometer squares) with a pitch of 20 micrometers and a passivation layer. Exemplary pixels of this type were used to fabricate a 16×16 square array of pixels of an exemplary integrated circuit.

In this exemplary embodiment, each pixel comprised a set of 9 pads, arranged in a 3×3 square grid. Underneath each pad, there was an individually addressable and highly configurable integrated circuit (IC). By applying a desired voltage while measuring a resulting current via trans-amplification, each pad could function as a potentiostat. On the other hand, by injecting a desired current while measuring a resulting voltage with an op-amp in a buffer mode, the pad could function as a galvanostat. Lastly, operating the pad in a voltage buffer mode allows OCP sensing, as a current flowing through the electrode was zero.

By leveraging the chip's highly configurable IC, electrochemical walls were created between pixels of the array for dense confinement of protons, as described in greater detail elsewhere herein. By configuring the anode in a galvanostat mode, a positive current was injected to induce oxidation for proton generation. Likewise, a negative current was injected through a cathodic ring to induce a reduction reaction for base generation. The generated volume of base served as an electrochemical wall that confined protons within each concentric pixel.

The pad in the center of the 3×3 square grid of each pixel was operated as an OCP sensor to detect pH. The pads adjacent to the center pads were connected by a first conductive ring, which served as the anode of the pixel. The remaining four pads, in the corner positions of the 3×3 square grid, were connected by a second conductive ring, which served as the cathode of the pixel. Pixels were post-fabricated onto the pre-defined array by first using photolithography to define a desired pattern for circular pads (diameter: 8 micrometer), annular anodes (inner and outer diameters: 26 micrometer and 36 micrometer), and annular cathodes (inner and outer diameters: 58 micrometer and 62 micrometer). Then, a passivation layer was removed to expose the Al pads via reactive-ion etching. Finally, a thick metal layer (15 nm Ti and 200 nm Pt) was sequentially deposited via sputtering. After the electrode fabrication, in the case where <20 micrometer of substrate height was needed, an SU-8 spacer layer was fabricated above and below the array with 1 mm spacings via photolithography. After the post-fabrication, the chip was wire-bonded to a chip carrier (Spectrum Semiconductor Materials, San Jose, CA) via a custom designed interposer printed circuit board (PCBWay, Shenzhen, China). A glass outer ring (Friedrich & Dimmock, Millville, NJ) and a laser-cut acrylic inner ring were glued to the chip carrier and the chip, respectively, with polydimethylsiloxane (PDMS). PDMS was then poured in between the rings to encapsulate the wire-bonds and metal interconnect lines.

Then, a glass substrate was placed on top of the CMOS-MEA at a fixed substrate height, which was determined by the thickness of the spacer layer. This produced a chamber, defined on one side by an integrated circuit and on the other by a second substrate. For a substrate height greater than 20 micrometers, a Kapton tape (McMaster Carr, Princeton, NJ) with a known thickness was used for the spacer. For a substrate height less than 20 micrometers, photolithography was performed to make an SU-8 layer with a desired thickness. An Ag/AgCl electrode was used as a pseudo-reference electrode, serving the roles of both a reference electrode and a counter electrode. Given this setup, a desired set of stimulation currents was applied to the anodic and cathodic rings at the selected pixels for array-wide pH localization, while OCP sensors monitored the spatiotemporal pH profile concurrently.

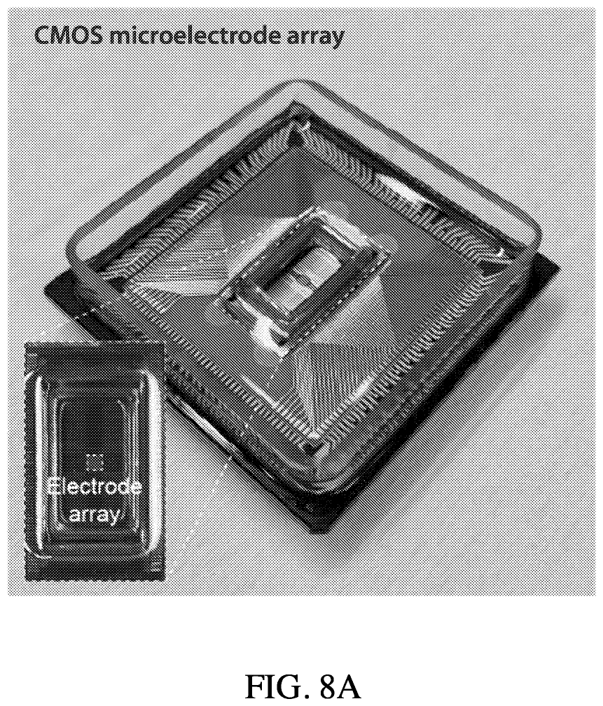

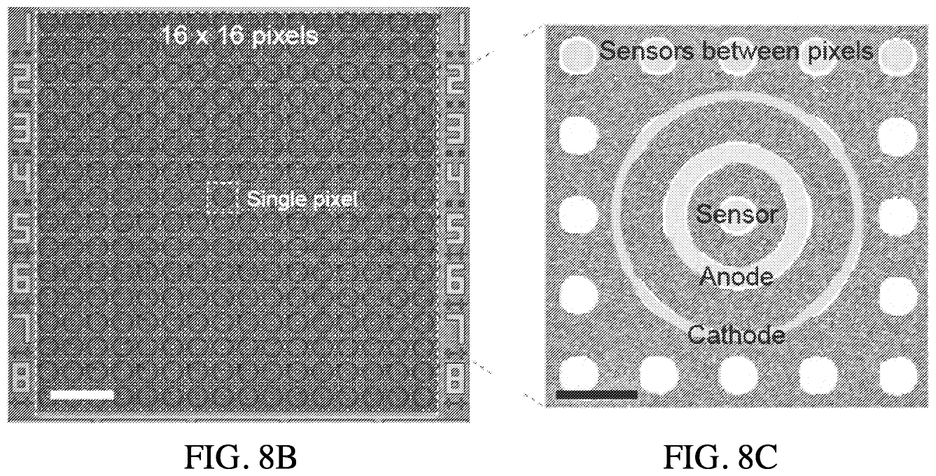

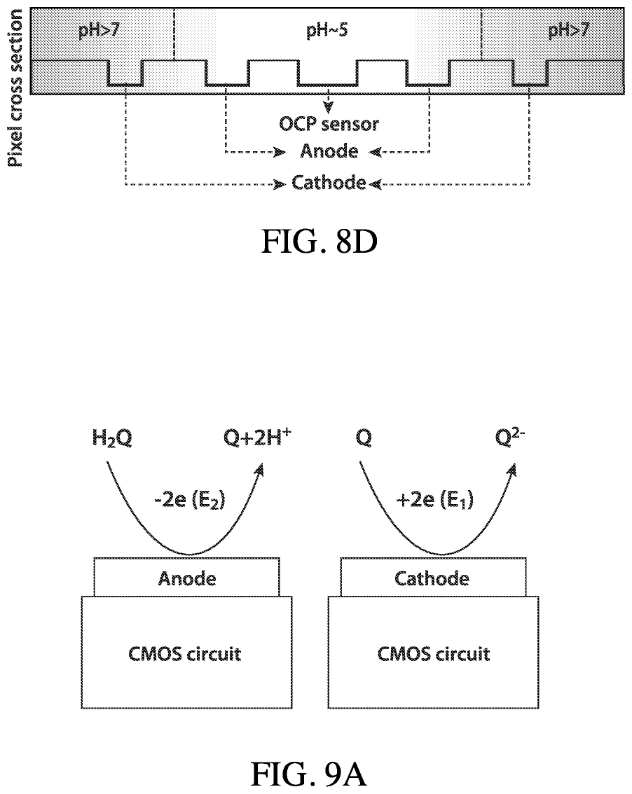

FIG. 8A presents a perspective image of an integrated circuit. FIG. 8B shows an SEM image of an exemplary pixel array (with a 200 micron scale bar), while FIG. 8C presents a more magnified image of a single pixel (with a 20 micron scale bar), in some embodiments. The array is similar to the array shown in FIG. 1B, but comprises circular pads rather than square pads. Between each adjacent pair of exemplary pixels of the array of exemplary pixels was a row or column of additional sensing electrodes in FIG. 8C. These may be operated as OCP sensors to detect pH between pixels at their locations. FIG. 8D presents a cross-sectional schematic illustration of a pixel, according to some embodiments.

### Example 3

In this example, the chamber comprising the multi-modal CMOS microelectrode array (CMOS-MEA) of Example 2 was used. In order to control the pH of the pixels, the exemplary integrated circuit was placed in contact with a solution comprising 2,5-dimethyl-1,4-hydroquinone, an electrically sensitive pH modifier. In order to localize the change in pH to the exemplary pixel, a negative voltage or current was applied to the second conductive ring, in order to negate the positive potential applied at the first conductive ring, such a net potential applied by the pixel is near-zero, except within a portion of the solution proximate to the exemplary pixel. With this electrochemical approach, pH could be densely localized and monitored for any arbitrary combination of the pixels in a random-access manner.

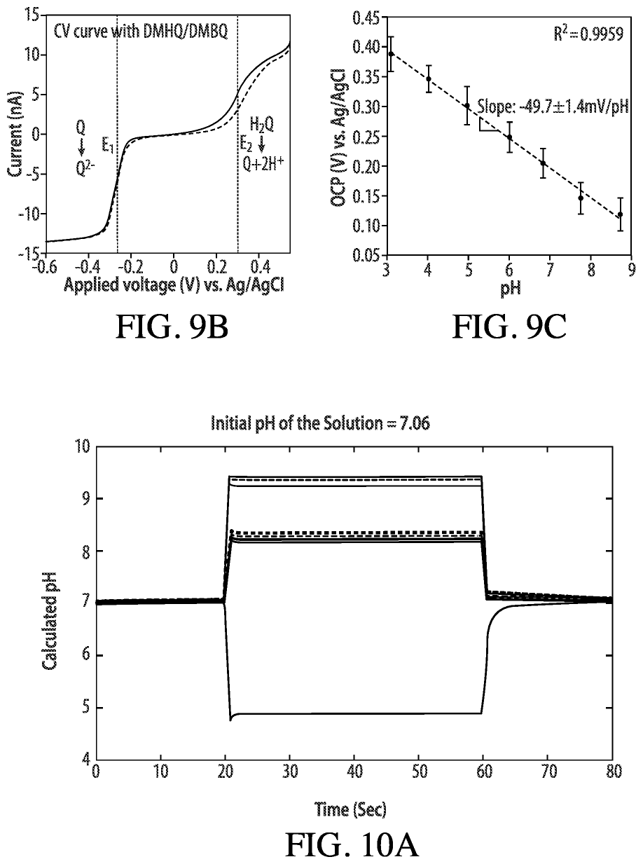

FIG. 9A presents a schematic of redox reactions of 2,5-dimethyl-1,4-hydroquinone (“H₂Q”) and 2,5-dimethyl-1,4-benzoquinone (“Q”). The oxidation reaction generates protons, while the reduction reaction generates quinone dianions (“Q²⁻”), which serve as base. In order to characterize the relevant electrochemical reactions in the quinone solution used in this example, cyclic voltammetry (CV) was performed by operating a single pad in a potentiostat mode. FIG. 9B presents a cyclic voltammogram at a single circle electrode. Scan range from −0.6 V to 0.5 V with a scan rate of 20 mV/s. The CV curve showed that the main redox species was the H₂Q/Q redox couple, as its oxidation and reduction curves dominate the CV curve. When a positive current was injected, H₂Q was irreversibly oxidized into Q and two protons, as voltage was swept across a half wave potential of E₂˜0.3 V, generating protons (see FIG. 3). Likewise, when a negative current was injected, Q was reversibly reduced into a dimethyl quinone dianion (labeled as Q²⁻), as voltage was swept across a half wave potential of E₁˜−0.3 V, generating base for proton confinement.

Concurrently with pH control occurring at the anode and the cathode, spatiotemporal pH profile was monitored in real time by 2,048 OCP sensors located between pixels and at pixel centers. Based on the principle of potentiometric pH measurement, an OCP change was converted to a pH change by dividing the OCP change by an experimentally determined pH sensitivity (−49.7±1.4 mV/pH) of the annular Pt electrodes (FIG. 9C). FIG. 9C presents OCP vs. pH calibration. The platinum OCP sensor shows a linear pH response with a sensitivity of −49.7±1.4 mV/pH. OCP sensors at the center of the pixels measured pH within the pixel, while OCP sensors between measured localization of the pH.

### Example 4

This example demonstrates the control of pH using exemplary pixels of the type described in Example 2. First, a solution comprising H₂Q, with an initial pH of 7.06 was placed in contact with the exemplary integrated circuit. The spatial pH distributional was monitored for 20 seconds. Then, current was supplied to a pixel in order to locally change the pH. A constant current was maintained for 40 seconds before current was reduced to zero. Throughout this process, pH was continuously monitored.

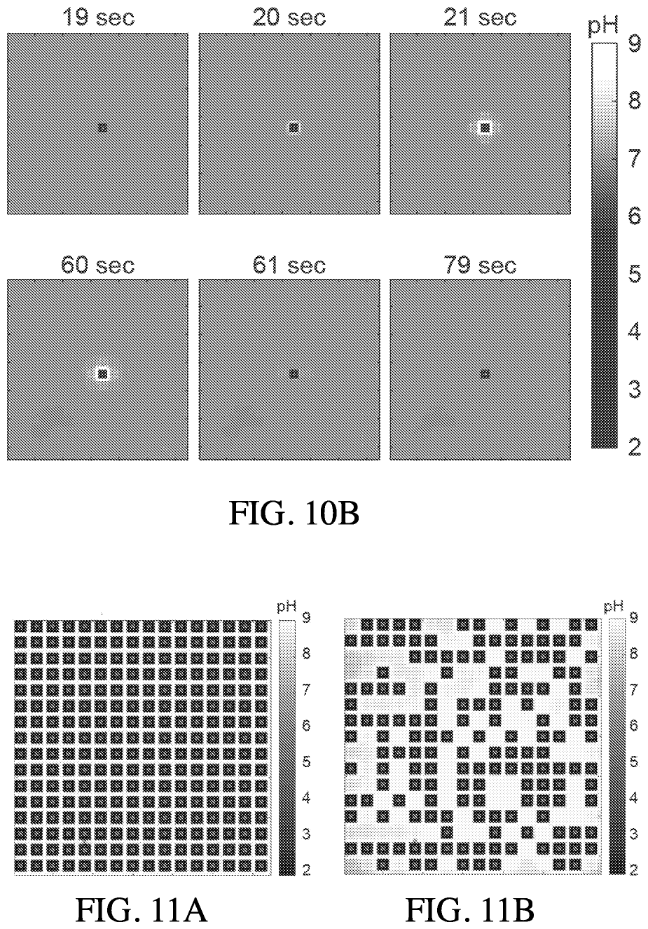

Results for this experiment are presented in FIG. 10A-10B. FIG. 10A presents the local pH of several configurable pixel circuits of the integrated circuit as a continuous function of time. At the onset of current stimulation, each configurable pixel circuit detected a rapid change in pH followed by a long period of localized steady-state at each pixel. Finally, at the conclusion of current stimulation, the pH of every location rapidly returned to its steady-state value of 7.06. FIG. 10B, meanwhile, present the spatial distribution of pH on the integrated circuit measured at labeled time-points.

These results demonstrate that the spatial distribution of pH can be precisely controlled by this exemplary integrated circuit, that pH can be localized to a specific pixel of the exemplary circuit, and that the change in pH upon the onset of electrical stimulation occurs very rapidly.

### Example 5

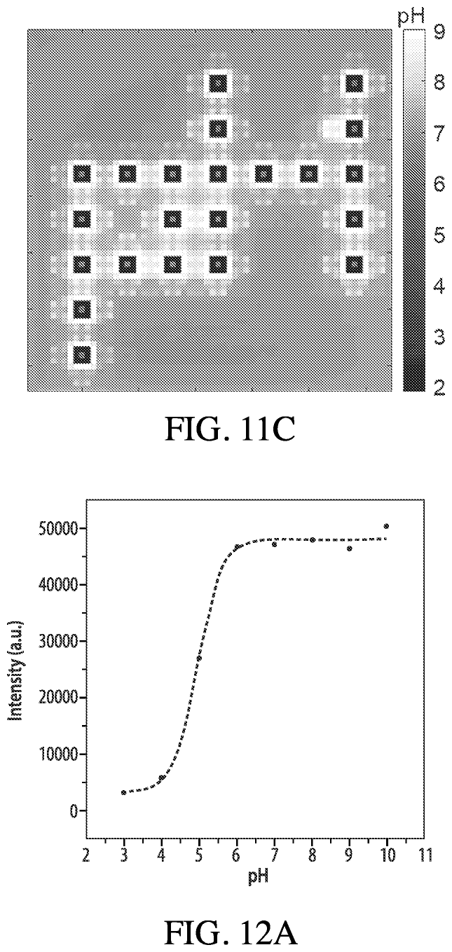

Some aspects of the present disclosure relate to writing DNA sequences in a spatially random fashion. The inventors have recognized and appreciated that for applications such as DNA information storage, it is desirable to write DNA sequences in a spatially arbitrary manner, which requires pH to be localized in a spatially arbitrary manner as well. Challenges may arise because spatially different current stimulus profiles lead to different diffusion dynamics, which lead to varying spatial pH profiles. The inventors have recognized and appreciated that such a problem may be solved by balancing out anodic and cathodic currents locally to a very fine precision, so that pixels can get effectively decoupled (i.e., neighboring pixels have minimal cross talk with one another). In some embodiments, anodic and cathodic currents at respective electrodes are finely balanced, such that electrochemically generated acid at the anode is stably localized by the surrounding, electrochemically generated base at the cathode. Balancing anodic and cathodic currents may be performed using the pixel circuitry coupled to the anode and cathode, and a controller configured to adjust the stimulation currents at respective electrode, although any suitable method may be used. FIGS. 11A-11C illustrate results of pH localization at an array level for an arbitrary stimulation pattern, where pH values at the center sensing electrodes were consistently around 5.

In this example, simultaneous, local control of pH was demonstrated for multiple pixels on the exemplary integrated circuit. These results are presented in FIGS. 11A-11C, which are analogous to the spatial distributions of pH presented in FIG. 10B. To achieve this, the chamber of Example 2 was first filled with the deprotection solution of Example 1. Then, the anode and the cathode of each pixel of the device were provided with current, as in Example 2.

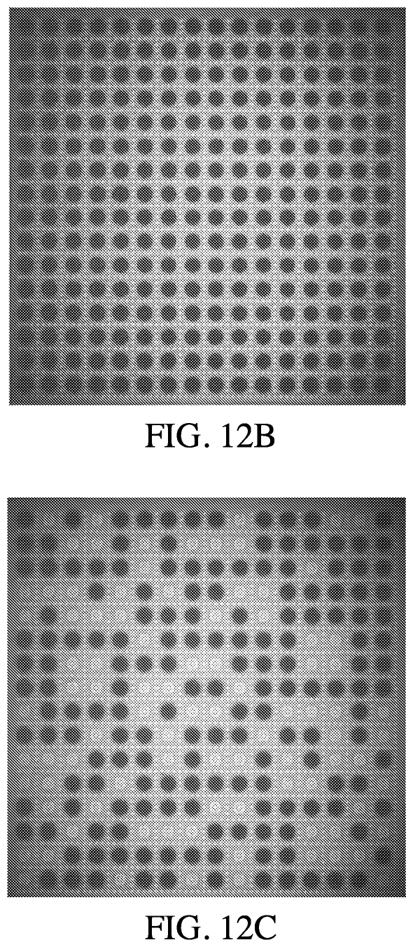

In order to confirm the accuracy of pH measurements, 10 micromolar fluorescein disodium (VWR International, Pittsburgh, PA), a pH dependent fluorophore, was additionally added to the deprotection solution, and the fluorescent intensity of each pixel was measured using epifluorescence microscopy. FIG. 12A is a graph representing the measured fluorescent intensity of the fluorescein as a function of pH in a calibration experiment. FIGS. 12B-12C are epifluorescent micrographs, where darker regions correspond to a lower fluorescent intensity. In FIG. 12B. pH was localized to a first pH condition at each pixel, resulting in a perfect array of fluorescent pixels. In FIG. 12C. pH was localized to the first pH condition at a random subset of the pixels, resulting in the illustrated fluorescence pattern. The observed spatial distribution of fluorescence closely matched the spatial distribution of pH measured by the OCP sensing configurable pixel circuits, confirming the accuracy of these measurements.

### Example 6

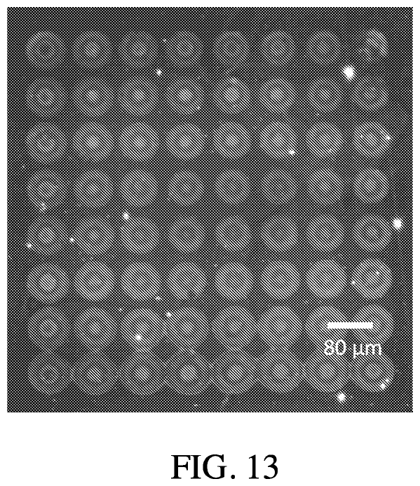

In this example, deoxyadenosine triphosphate (dATP, a dNTP) labeled with the Cy5 fluorophore was selectively reacted with an exemplary array of pixels of an integrated circuit via the procedure described in Example 1. Following the deposition of the labeled nucleobase onto a second substrate above the pixel array, the second substrate was removed and fluorescently imaged. The fluorescence profile of the second substrate demonstrated a regular array of circular sites with an 80 micrometers diameter. This fluorescence profile, presented in FIG. 13, demonstrates that the protection of the second substrate via localized pH control by the pixels resulted in localized deposition of the labeled nucleobase.

### Example 7

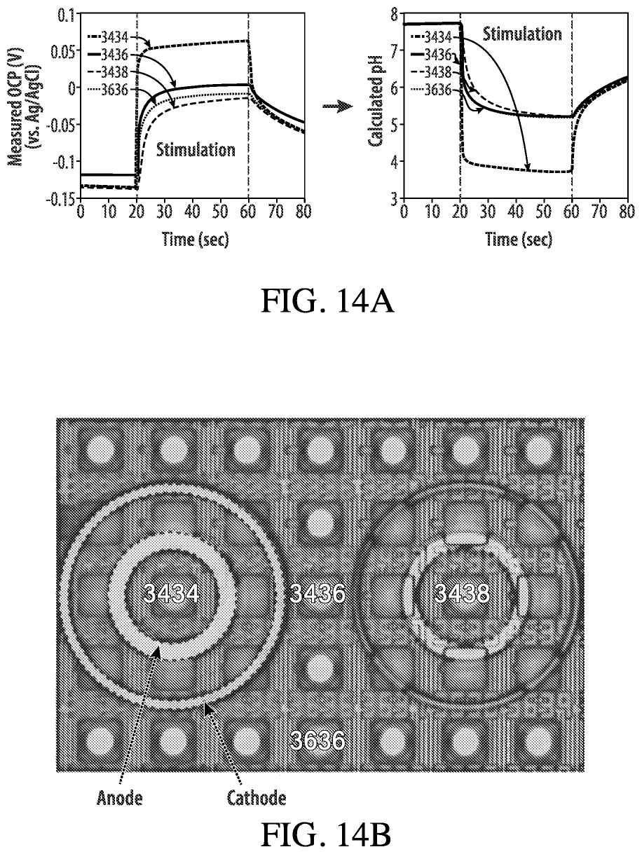

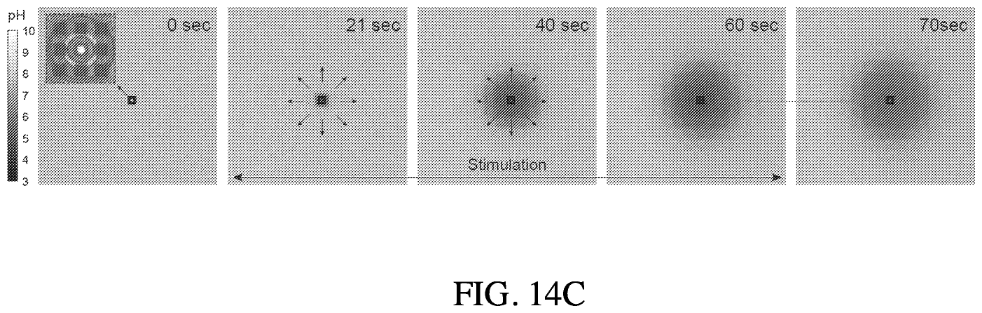

To demonstrate that an electrochemical wall was needed to localize pH in the quinone solution, as a control experiment, a spatiotemporal pH profile was monitored concurrently with a current stimulation at a single anodic ring. During this experiment, every electrode, excluding the single anodic ring but including every other ring electrode, was configured into an OCP sensor mode. pH calculated from a center OCP sensor shows that the pH drops below 4.0 during 40 seconds of stimulation with 57 nA. FIG. 14A presents a single pixel stimulation at an anodic ring at locations shown in FIG. 14B. The optical microscope image shows the location of the labeled pads. Location 3434 refers to the pad location at row 34 and column 34, where both row and column numbers ranged from 1 to 64. A measured OCP change is converted to a pH change using the calibration result. Spatiotemporal pH monitoring showed that the electrochemically generated acid spread radially outward during the stimulation, and showed that the pH profile slowly recovered to the original condition after the stimulation ended. FIG. 14C presents spatiotemporal pH monitoring during an anodic stimulation. The pH maps clearly show a radial diffusion of protons generated by an anodic stimulation. No substrate was placed for this experiment. Similarly, when a negative current was applied to a single cathodic ring, the electrochemically generated base spread radially outward.

### Example 8

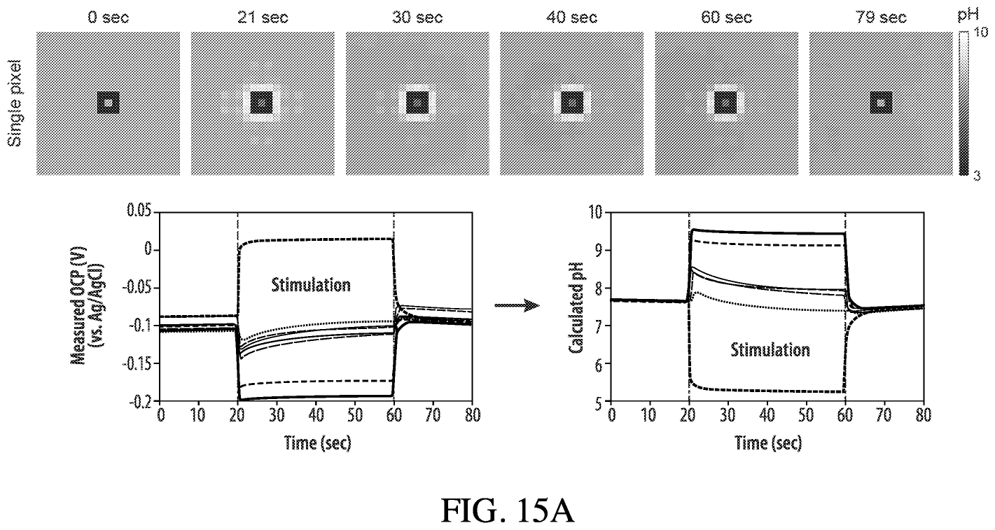

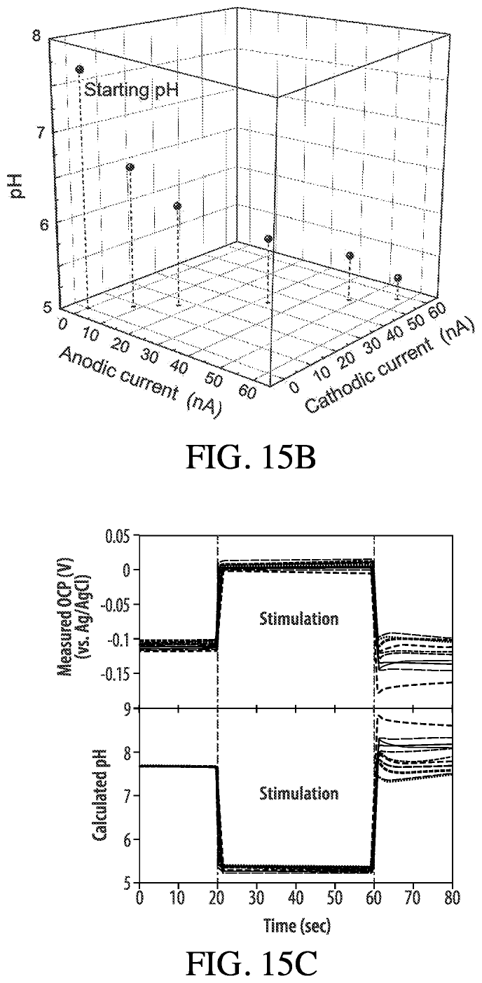

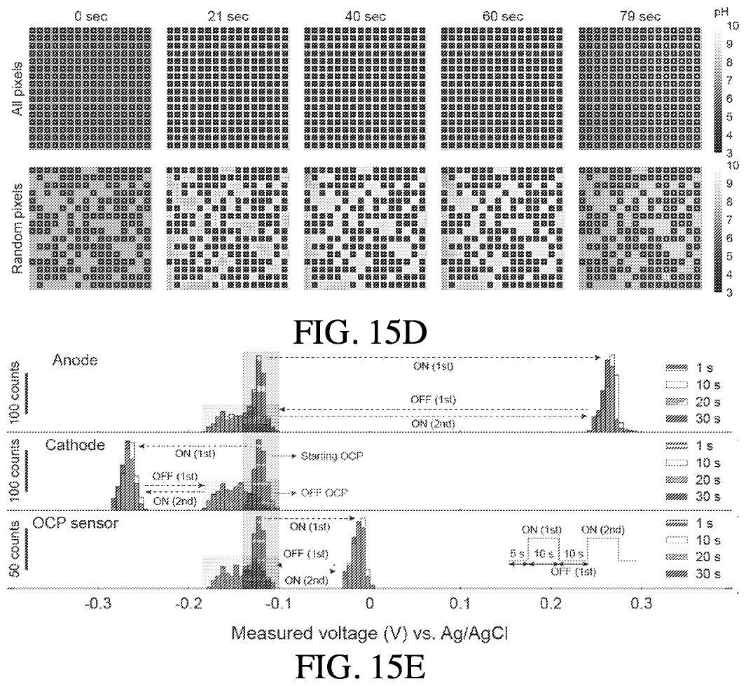

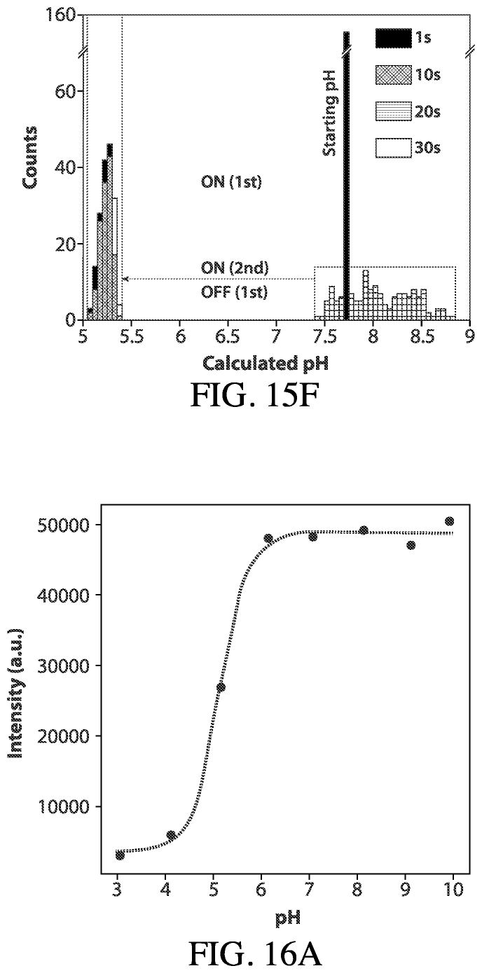

This example further demonstrates an array-wide pH localization in water by constructing electrochemical walls across the array. 57 nA of anodic current and −57 nA of cathodic current was applied to a single concentric pixel of the integrated device of Example 2. FIG. 15A presents pH localization at a single concentric pixel. For clarification, it is noted that because ring electrodes were post-fabricated on top of four pre-defined pads, a spatial pH map possesses an artifact of showing an identical pH value at the four connected pads. Spatiotemporal pH monitoring, presented in FIG. 15A, clearly showed that an acidic pH of 5.26 was successfully localized throughout 40 seconds of stimulation. The confined acid vanished as soon as the stimulation ended. By adjusting the anodic and cathodic currents, the target pH value could be tuned to a different value as well, while maintaining a successful pH confinement. FIG. 15B presents the variation of stimulation parameters for tuning localized pH.

By extending the electrochemical wall construction across the array, pH localization was successfully achieved for any arbitrary stimulation pattern. For example, FIG. 15C presents measured OCP voltage and calculated pH as a function of time for a series of pixels, while FIG. 15D presents spatial distribution of pH for an array-wide pH localization for all 256 pixels (top) and randomly selected pixels for pH localization (bottom). The substrate height was about 25 micrometers. Localized pH values within the walls were very similar to one another; in the case of stimulating the entire array, the pH distribution had a median of 5.33 and a standard deviation of 0.029. In fact, the pH control capability was not limited to a particular solution. For various solution compositions, including a composition that has no pH buffer, pH was successfully localized across the entire array.

This success was attributed largely to the chip's ability to simultaneously stimulate any combination of pixels with current values that were finely tunable with a sub-nA resolution. In the case of voltage stimulation, a change in the concentration of quinones would lead to a change in the resulting currents, rendering a change in the rates of the redox reactions. On the other hand, current stimulation directly controls the rates of the redox reactions. Given that an optimal balance in the rates at which acids and bases were being generated was needed to localize pH, voltage stimulation was naturally more vulnerable to concentration changes of the redox species.

In addition to localizing pH for an arbitrary stimulation pattern, the electrochemical reaction dynamics could also be reversibly controlled. To test this, two square pulses of currents (57 nA of anodic current and −57 nA of cathodic current) were applied to all 256 pixels, while monitoring potentials were measured at anodes and cathodes. In a galvanostat mode, a measured potential was a potential that developed at the electrode in order to supply a desired current. In the case where redox species were locally depleted, a concentration overpotential develops. If such overpotentials were measured at any time during a current pulse experiment, it would be known that the spatial concentration profile of the redox species has been significantly altered to the extent of making the control of the reaction dynamics irreversible. In this example, it was seen that the distribution of the measured potentials at anodes and cathodes remained almost identical from the first pulse to the second pulse, indicating that the redox reactions was being controlled reversibly. FIG. 15E presents distributions of measured potentials at anodes, cathodes, and center OCP sensors during a current pulse stimulation. The bin size was 5 mV. Likewise, the distribution of OCP values, and thus pH values, remained almost identical. FIG. 15F presents distributions of localized pH values during a current pulse stimulation. The bin size was 0.05.

### Example 9

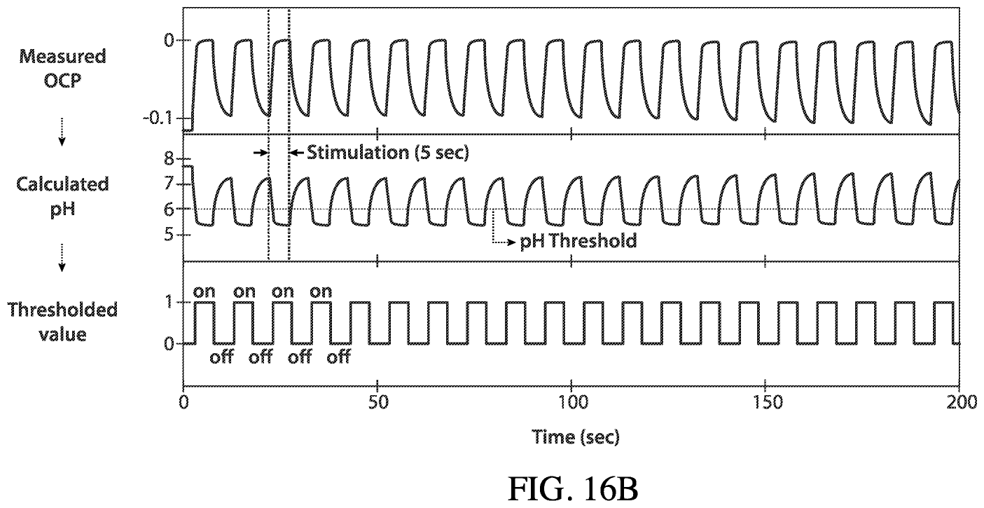

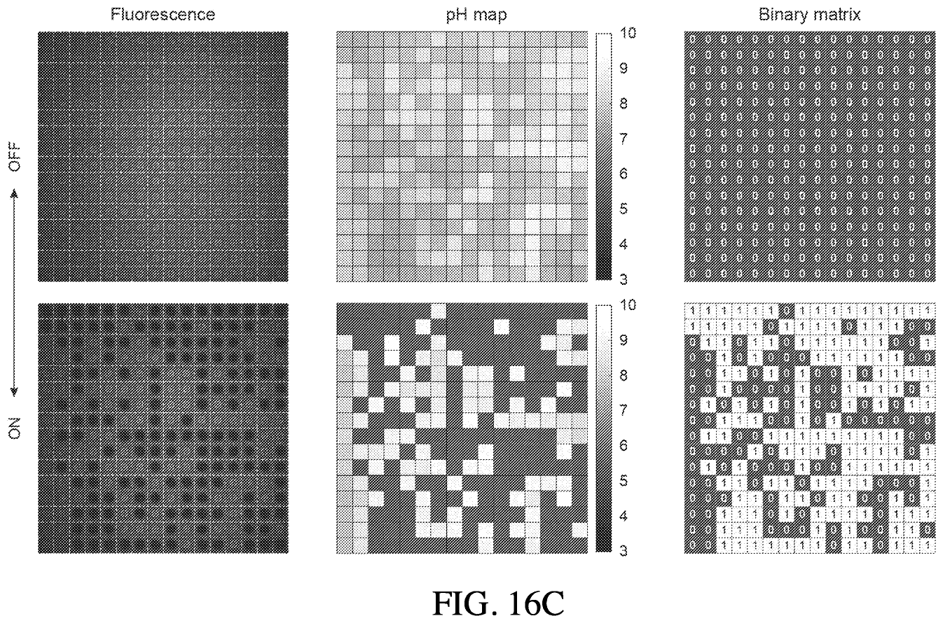

By reversibly controlling and monitoring pH across the array, it was shown that the chip described in this example could parallelize pH-gated molecular state encoding. Fluorescein was a pH-dependent fluorophore that has been widely used for optical probing of pH. It fluoresces only in either dianionic or monoanionic form, and was non-fluorescent in its neutral, fully protonated form. An individual fluorescein molecule can be either in the unprotonated anionic state ‘O’, which fluoresces, with a probability p₀, or in the fully protonated neutral state ‘1’, which does not fluoresce, with a probability p₁=1−p₀. The probability p₀ increases with pH and saturates to 1 as pH exceeds 6.65 in the 10 micromolar aqueous fluorescein solution. Thus, the collective fluorescence intensity, which is proportional to p0, increases with pH and saturates to the maximum as pH exceeds 6.65, creating a plateau where all fluorescein molecules are in the ‘O’ state with p₀=1 (FIG. 16A). Conversely, as pH is lowered from 6.65, p₀ decreases, reducing the collective fluorescence intensity. Therefore, when acidic pH is localized at a select set of pixels, the fluorescence intensity from each pixel will be reduced, as an appreciable fraction of fluorescein molecules there will be encoded into state ‘1’. In contrast, the fluorescein molecules in the remaining inactivated pixels will preferentially remain in the ‘0’ state, exhibiting stronger fluorescence intensity. FIG. 16A presents a calibration curve for epifluorescence intensity as a function of pH. The substrate height is about 13.8 micrometers. By employing fluorescein molecules as a data storage medium, it was demonstrated that the chip could operate as a 256-bit molecular RAM.

In this operation, each concentric pixel serves as a memory cell holding one bit of information. Data could be written into the pixel array by electrochemically localizing picoliters of acids within each pixel. At the same time, data could also be read by calculating pH from an OCP measurement, which was converted to a binary value by thresholding at pH=6.0. Given that acidic environments vanish as soon as a current stimulation ends, it was immediately seen that the stored information was volatile. Also, because the chip was capable of simultaneously performing write and read operations for an arbitrary subset of its 256 pixels, data could be written and read in a random-access manner.

To showcase this operation, a sequence of twenty sets of anodic and cathodic current pulses (48 nA and −48 nA, respectively) was applied to an arbitrarily selected group of pixels in parallel. Each pulse was 5 s long, and there was a 5 s time lapse between each pair of adjacent pulses. The sequence of pulses was applied to an arbitrary group of pixels in parallel. At the same time, pH values at all pixels were monitored using the pixel center OCP sensors. FIG. 16B presents an graphs of the measured OCP and pH vs. time in an example stimulated pixel. The acidic pH values reached within all select pixels were close to one another at any given time, with their distribution nearly identical from pulse to pulse: the median/standard deviation at 1=6 s (1^{st} pulse), 95 s (10^{th} pulse), and 196 s (20^{th} pulse) were 5.54/0.06, 5.58/0.07, and 5.65/0.10, respectively. By concurrently performing epifluorescence measurement of pH, which was consistent with the on-chip electronic pH measurement, it was confirmed that in each of these selected pixels, an appreciable fraction of fluorescein molecules converted to state ‘1’ every time acidic pH voxels formed (e.g., approximately 20% of fluorescein molecules were in state ‘1’ for pH=5.54), whereas in each of the unstimulated pixels, nearly all fluorescein molecules remained in state ‘0’ (FIG. 16C). FIG. 16C presents a parallelized pH-gated molecular state encoding for a non-limiting stimulation pattern. This example demonstrates the parallel execution of the pH-gated molecular state encoding at any selected pixels.

### Example 10

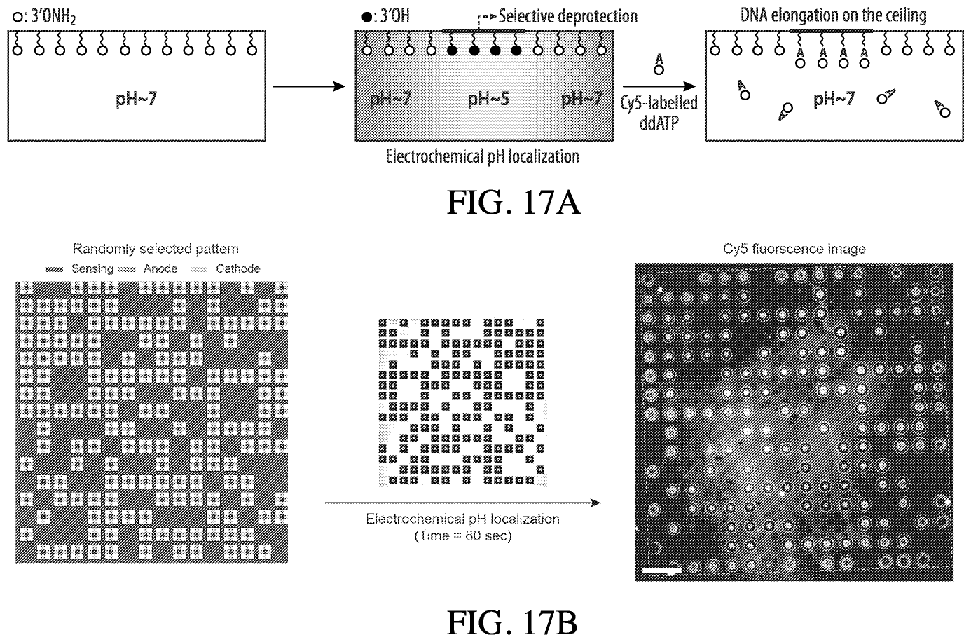

In this example it was shown that by electrochemically localizing pH in water, deprotection chemistry of DNA's reversible terminators could be controlled spatio-selectively, allowing array-wide, enzymatic DNA elongation on a removable glass substrate for non-volatile information encoding. Initially, single stranded DNA strands were attached to a removable glass substrate via a silane-free acrylamide-coated glass substrate as described in Example 1. Then, the attached DNA strands were elongated with dTTP-3′ONH₂, as described in Example 1. This step changed the terminating group of DNA strands attached to the removable substrate from 3′OH to 3′ONH₂, a reversible terminating group compatible with TdT enzymes. In order to elongate DNA strands that were protected with 3′ONH₂ groups, the DNA strands need to be deprotected by converting 3′ONH₂ groups to 3′OH groups. By creating locally acidic microenvironments within a sodium nitrite solution buffered to a pH of 5.5, 3′ONH₂ capped DNA strands were deprotected within minutes at pre-specified pixels of the array (FIG. 17A). FIG. 17A presents a schematic of 1 nt enzymatic elongation of DNA on a glass substrate with spatio-selectivity. The substrate height is about 13.8 micrometers. The scale bar is 160 micrometers.

Then, non-volatile data could be written into the deprotected strands by enzymatically elongating them with Cy5-labelled ddATP (as described in Example 1) and then read the data by measuring Cy5 fluorescence signals with an epifluorescence microscope.

To test this hypothesis, 48 nA of anodic current and −48 nA of cathodic current was applied to a randomly selected group of pixels. After successfully localizing pH for 80 seconds, the deprotected strands were enzymatically elongated with Cy5-labelled ddATP (see Methods). The observed Cy5 fluorescence pattern was identical to the current stimulation pattern. FIG. 17B presents an epifluorescence image of spatio-selectively deprotected sites after an enzymatic elongation of DNA with Cy5-labelled ddATP. The Cy5 fluorescence pattern matches the stimulation pattern exactly. This result demonstrates the ability to deprotect DNA's reversible terminators spatio-selectively for an arbitrary pattern, allowing non-volatile, molecular encoding of information at desired sites via enzymatic DNA elongation.

### Example 11

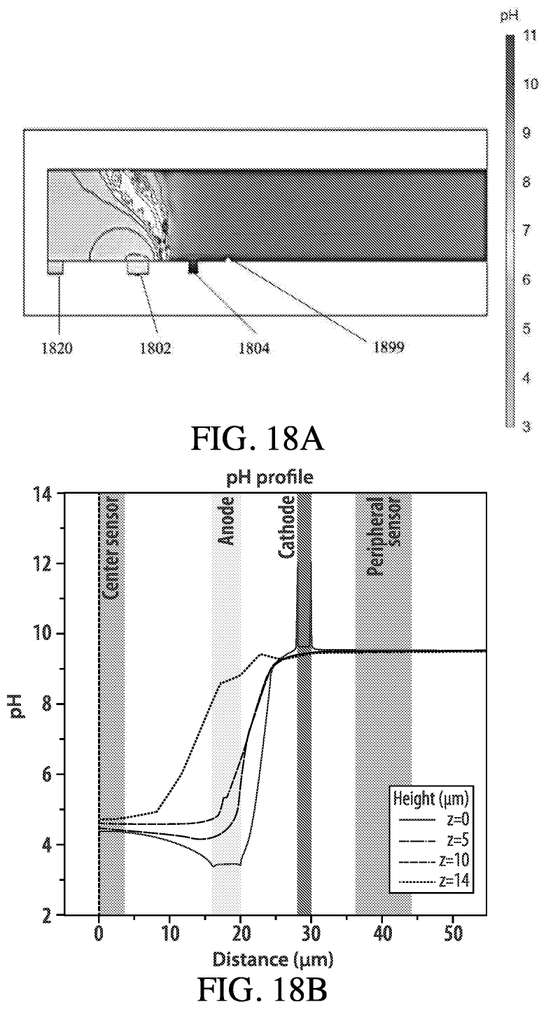

This example shows a calculation of the pH of a non-limiting solution in contact with a simulated pixel of the type shown in FIG. 8C (described above, in the context of Example 2), positioned 14 microns below a second substrate. COMSOL simulations were performed to understand the full 3-dimensional (3D) pH profile associated with the activated pixel, assuming an anodic current of 76 nA and a cathodic current of −76 nA. FIG. 18A presents a cross-sectional schematic of pH sensor 1820, first electrode 1802 (an anode), and second electrode 1804 (a cathode). FIG. 18A further illustrates the resulting pH distribution within a cross-section of the solution directly above pH sensor 1820 (an electrode pad), first electrode 1802, second electrode 1804, and peripheral sensor 1899 (also an electrode pad). These simulations confirmed the pH localization at the pixel, creating a steep pH gradient between the central pH sensor and the peripheral pH sensor.

FIG. 18B presents the pH of the solution of FIG. 18A, computed at fixed heights z above the substrate, at various lateral distances from the center of the pixel. As shown, the pH near sensor 1820 remained stable at least 14 microns above sensor 1820. However, as expected, the steepness of the pH gradient decreased with increasing height above the substrate, and the portion of the pH profile with the steepest gradient grew closer to the central sensor. These measurements demonstrate that the pixels produce long-range pH effects, and illustrate that the pixel may be used to control the pH of the solution in contact with a second substrate positioned on an opposite side of a fluidic chamber with a 14 micron chamber width.

### Example 12

Like Example 11, this example shows a calculation of the pH of a non-limiting solution in contact with a simulated pixel of the type shown in FIG. 8C (described above, in the context of Example 2). In this example, the pixel is positioned 300 microns below a second substrate. COMSOL simulations were performed to understand the full 3-dimensional (3D) pH profile associated with the activated pixel, assuming an anodic current of 73 nA and a cathodic current of −73 nA.

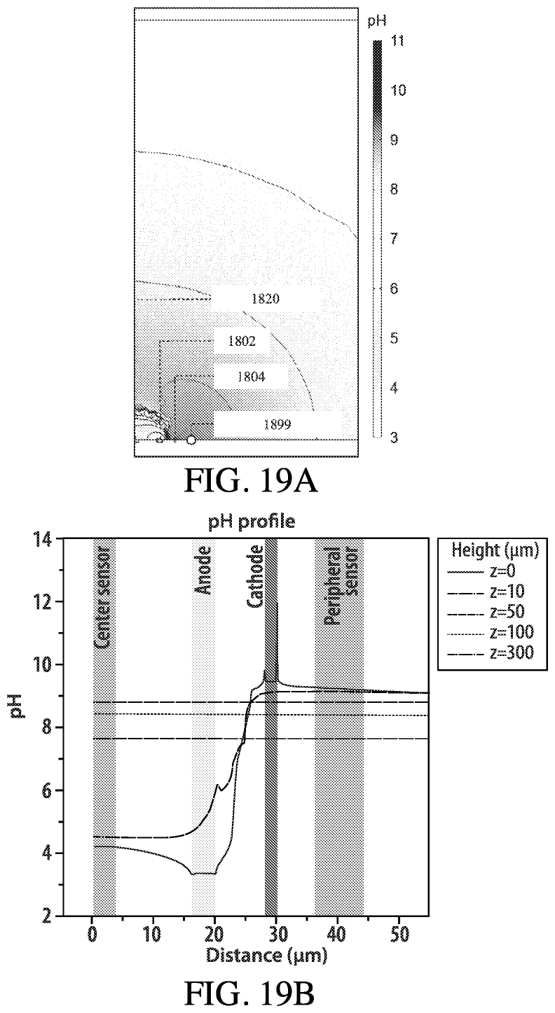

FIG. 19A is similar to FIG. 18A shown in Example 11, and shows a cross-sectional schematic of pH sensor 1820, first electrode 1802 (an anode), and second electrode 1804 (a cathode), as well as the pH distribution calculated for the surrounding solution. A sphere-like dome with a low pH was observed to form near the pixel, while the solution further from the dome had a high pH, as shown. FIG. 19B demonstrates this more clearly. Like FIG. 18B, FIG. 19B shows the pH as a function of lateral distance from the center of the pixel at various heights. As shown, at 0 or 10 microns above the surface, the pH was controlled by the pixel, resulting in a sharp pH gradient. However, at 50, 100, or 300 microns above the substrate, the pH was effectively constant, and did not show any serious dependence on lateral position. This example demonstrates that pH can be controlled as a function of 3-dimensional position, and illustrates that the pixel's effect on pH is limited at sufficient distance from the pixel.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of.” or, when used in the claims, “consisting of.” will refer to the inclusion of exactly one element of a number or list of elements. In general, the term “or” as used herein shall only be interpreted as indicating exclusive alternatives (i.e. “one or the other but not both”) when preceded by terms of exclusivity, such as “cither,” “one of,” “only one of.” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A device, comprising:
a substrate comprising an integrated circuit comprising a plurality of pixels, wherein at least some of the pixels in the plurality comprise a first electrode defining a first interior, a second electrode defining a second interior, and a pH sensor, wherein the first interior is at least partially contained within the second interior, and wherein the pH sensor is present within the first interior and/or the second interior.

2. The device of claim 1, wherein an average pixel diameter is less than or equal to 100 micrometers.

3. The device of any one of claims 1-2, wherein an average pixel diameter is less than or equal to 50 micrometers.

4. The device of any one of claims 1-3, wherein an average pixel diameter is less than or equal to 20 micrometers.

5. The device of any one of claims 1-4, wherein an average interpixel spacing is less than or equal to 100 micrometers.

6. The device of any one of claims 1-5, wherein an average interpixel spacing is less than or equal to 60 micrometers.

7. The device of any one of claims 1-6, wherein an average interpixel spacing is less than or equal to 20 micrometers.

8. The device of claim any one of claims 1-7, wherein the pH sensor is an OCP sensor.

9. The device of any one of claims 1-8, wherein the plurality of pixels is a two-dimensional array.

10. The device of any one of claims 1-9, wherein the two-dimensional array is a square array.

11. The device of any one of claims 1-10, wherein a pixel density is greater than or equal to 100/mm².

12. The device of any one of claims 1-11, wherein a pixel density is greater than or equal to 250/mm².

13. The device of any one of claims 1-12, wherein a pixel density is greater than or equal to 500/mm².

14. The device of any one of claims 1-13, wherein a number of pixels in the plurality of pixels is greater than or equal to 200.

15. The device of any one of claims 1-14, wherein a number of pixels in the plurality of pixels is greater than or equal to 1,000.

16. The device of any one of claims 1-15, wherein a number of pixels in the plurality of pixels is greater than or equal to 4,000.

17. The device of any one of claims 1-16, wherein the first electrode is annular.

18. The device of any one of claims 1-17, wherein the second electrode is annular.

19. The device of any one of claims 1-18, wherein the first electrode and the second electrode are concentric.

20. The device of any one of claims 1-19, wherein a portion of the first interior is not a portion of the first electrode.

21. The device of any one of claims 1-20, wherein the first electrode is a positive electrode and the second electrode is a negative electrode.

22. The device of any one of claims 1-20, wherein the first electrode is a negative electrode and the second electrode is a positive electrode.

23. A method, comprising:
flowing a solution containing an electrically sensitive pH modifier into a device as in any one of claims 1-22;
reacting the electrically sensitive pH modifier in a first subset of the plurality of pixels to produce a pH change without producing the pH change in a second subset of the plurality of pixels; and
determining the pH at 50% or more of the sites.

24. The method of claim 23, wherein the electrically sensitive pH modifier comprises a quinone.

25. The method of any one of claims 23-24, wherein the quinone comprises 2,5-dimethyl-1,4-hydroquinone.

26. The method of any one of claims 23-25, wherein the quinone comprises 2,5-dimethyl-1,4-benzoquinone.

27. The method of any one of claims 23-26, wherein the quinone comprises 1,4-benzoquinone.

28. The method of any one of claims 23-27, wherein the quinone is saturated in solution.

29. The method of any one of claims 23-28, comprising attaching monomers at the first subset of the plurality of pixels to form a polymer sequence.

30. The method of claim 29, wherein the polymer sequence comprises nucleotides.

31. The method of any one of claims 29-30, wherein the polymer sequence comprises DNA.

32. The method of any one of claims 29-31, wherein the polymer sequence comprises RNA.

33. The method of any one of claims 29-32, wherein the polymer sequence comprises a peptide.

34. The method of any one of claims 29-33, wherein the number of the polymer sequences exceeds 50% of the number of pixels.

35. The method of any one of claims 29-34, wherein the polymer sequence encodes data.

36. The method of any one of claims 29-35, wherein the method further comprises removing at least a portion of the polymer sequence.

37. The method of any one of claims 29-36, wherein the method further comprises sequencing at least a portion of the polymer sequence.

38. The method of any one of claims 29-37, wherein the polymer sequence is formed on a second substrate.

39. The method of claim 38, wherein the second substrate is removable.

40. The method of any one of claims 38-39, further comprising removing the polymer sequence from the second substrate.

41. A device, comprising:
an integrated circuit comprising a plurality of pixels, wherein at least some of the pixels in the plurality comprise a first electrode, a second electrode, and a pH sensor; and
a solution contacting the plurality of pixels, the solution containing an electrically sensitive pH modifier.

42. A device, comprising:
a fluidic chamber having a substrate comprising an integrated circuit defining a plurality of pixels, wherein at least some of the pixels in the plurality comprise a first electrode defining a first interior and a second electrode defining a second interior, and an OCP sensor in electrical communication with the first electrode.

43. A device, comprising:
an integrated circuit comprising a plurality of pixels, wherein at least some of the pixels in the plurality comprise a first electrode defining a first interior and a second electrode defining a second interior, and wherein at least 90% of the plurality of pixels can independently be operated as a potentiostat, a galvanostat, or an OCP sensor.

44. A method, comprising:
exposing a substrate comprising an integrated circuit comprising a plurality of pixels to a solution containing as electrically sensitive pH modifier, wherein at least some of the pixels comprise a first electrode defining a first interior, a second electrode defining a second interior, and a pH sensor;
applying a current while determining voltage within a subset of the pixels, wherein the applied current within the subset of pixels causes oxidation or reduction of the electrically sensitive pH modifier depending on the polarity of the applied current;
determining the pH within at least some pixels of the subset using the pH sensor.

45. A method, comprising:
exposing a substrate comprising an integrated circuit comprising a plurality of pixels to a solution containing an electrically sensitive pH modifier, wherein at least some of the pixels comprise a first electrode defining a first interior, a second electrode defining a second interior, and a pH sensor;
applying a voltage while determining current within a subset of the pixels, wherein the applied voltage within the subset of pixels causes oxidation or reduction of the electrically sensitive pH modifier depending on the polarity of the applied voltage; and
determining the pH within at least some pixels of the subset using the pH sensor.
